(19) United States
(12) Patent Application Publication
(10) Pub. No.: US 2016/0009981 A1
(43) Pub. Date: Jan. 14, 2016

(54) ENHANCED OIL RECOVERY PROCESS TO INJECT LOW-SALINITY WATER ALTERNATING SURFACTANT-GAS IN OIL-WET CARBONATE RESERVOIRS

(71) Applicants: Tadesse Weldu Teklu, Golden, CO (US); Waleed Salem AlAmeri, Abu Dhabi (AE); Hossein Kazemi, Castle Rock, CO (US); Ramona M. Graves, Evergreen, CO (US); Ali M. AlSumaiti, Abu Dhabi (AE)

(72) Inventors: Tadesse Weldu Teklu, Golden, CO (US); Waleed Salem AlAmeri, Abu Dhabi (AE); Hossein Kazemi, Castle Rock, CO (US); Ramona M. Graves, Evergreen, CO (US); Ali M. AlSumaiti, Abu Dhabi (AE)

(21) Appl. No.: 14/643,523

(22) Filed: Mar. 10, 2015

Related U.S. Application Data
(63) Continuation-in-part of application No. 14/635,609, filed on Mar. 2, 2015.
Application No. 14/635,609 is a continuation-in-part of application No. 14/626,362, filed on Feb. 19, 2015.
(60) Provisional application No. 61/950,500, filed on Mar. 10, 2014.
(60) Provisional application No. 61/946,062, filed on Feb. 28, 2014.
(60) Provisional application No. 61/941,869, filed on Feb. 19, 2014.

(51) Int. Cl. C09K 8/584; E21B 43/16; C09K 8/594

(52) U.S. Cl. CPC C09K 8/584; C09K 8/594; E21B 43/166

(57) ABSTRACT

The present invention relates to a method to enhance oil recovery from a hydrocarbon reservoir. One aspect of the invention includes injecting low-salinity water into the reservoir followed by the injection of a surfactant diluted in low-salinity water, and alternating the injections of the low-salinity water and the surfactant diluted in the low-salinity water. A gas is then injected into the reservoir. The invention improves the effectiveness of the surfactant and the gas by reducing the salinity of the reservoir by injecting low-salinity water into the reservoir.

### CROSS REFERENCE TO RELATED APPLICATIONS

This application claims priority under 35 U.S.C. §119(e) to U.S. Provisional Patent Application Ser. No. 61/950,500 filed Mar. 10, 2014. This application is a Continuation-in-Part of U.S. patent application Ser. No. 14/635,609 (“the '609 Application”), filed on Mar. 2, 2015, which is a Continuation-in-Part of U.S. patent application Ser. No. 14/626,362 (“the '362 Application”), filed on Feb. 19, 2015. The '609 Application claims priority under 35 U.S.C. §119(e) to U.S. Provisional Patent Application Ser. No. 61/946,062 filed Feb. 28, 2014, and the '362 Application claims priority under 35 U.S.C. §119(e) to U.S. Provisional Patent Application Ser. No. 61/941,869 filed Feb. 19, 2014. All of these applications are incorporated by reference in their entirety.

### FIELD OF THE INVENTION

The invention relates to a method to enhance oil recovery by injecting low-salinity water, surfactant-augmented low-salinity water, and a gas or gas mixture into oil-wet carbonate reservoirs in an alternating scheme. These injections are applied after a high-salinity water injection.

### BACKGROUND

Conventional water flooding is widely used globally in carbonate oil reservoirs. The ultimate oil recovery from primary production and high-salinity waterflooding is significantly less than 50%. To recover additional residual oil after a high-salinity waterflood, gas flooding (such as CO₂), low-salinity water flooding, surfactant flooding, polymer flooding, steam flooding, or other enhanced oil recovery (EOR) methods can be implemented. However, low-salinity water flooding is not economical because it has to displace the already injected higher salinity water to mobilize additional residual oil.

It is believed that in carbonate formations, the carbonate rock surface attains a positive charge in presence of formation brine. The positive charge results from carbonate dissolution in brine, which also increases the solution pH. See Navratil, “An Experimental Study of Low-salinity EOR effects on a Core from the Yme Field” (Master Thesis, Petroleum Engineering Department, University of Stavanger). In presence of oil, the brine-soluble acidic components of the oil (carboxylate ions, R—COO⁻) are attracted to the positively charged carbonate rock surface. Some of these acidic oil molecules attach to the positively charged carbonate surface, which makes the surface oil-wet. This attachment is why restoring core wettability is critical factor in any improved oil recovery (IOR)/EOR experiments.

In presence of brine, the positively charged carbonate surface is amenable to anion exchange, which might be the reason for wettability alteration by the high-salinity water in traditional seawater flooding. In the latter, the sulfate, calcium and magnesium ions (SO₄²⁻, Ca²⁺, Mg²⁺) compete with the carboxylate (R—COO⁻) ions to partially alter the rock wettability from oil wet to water wet. See Austad et al., “Conditions for a Low-Salinity Enhanced Oil Recovery (EOR) Effect in Carbonate Oil Reservoirs,” Energy& Fuels, 26, 569-575 (2012).

Wettability alteration is a complex issue which, in addition to the brine ionic composition, also depends on reservoir temperature. See Austad et al. “Seawater as IOR Fluid in Fractured Chalk,” SPE-93000-MS. Presented at the SPE International Symposium on Oilfield Chemistry, The Woodlands, Tex., Feb. 2-4, 2005. Previous spontaneous imbibition of water experiments were conducted using oil-saturated cores from Ekofisk, Valhall, and Yates fields. The scientists that conducted those experiments observed that the presence of SO₄²⁻ improved the spontaneous imbibition regardless of the wetting conditions. Furthermore, studies on low-salinity waterflooding in carbonate reservoirs, with reduced Na⁺, indicate that Ca²⁺, Mg²⁺, and SO₄²⁻ play a major role in the wettability alteration. See Fathi et al. “Water-Based Enhanced Oil Recovery (EOR) by “Smart Water” in Carbonate Reservoirs,” SPE 154570, presented at the SPE EOR Conference at Oil and Gas West Asia, Muscat, Oman, Apr. 16-18, 2012; Austad et al. (2012); Awolayo et al. “A Laboratory Study of Ionic Effect of Smart Water for Enhancing Oil Recovery in Carbonate Reservoirs,” SPE 169662-MS, presented at the SPE EOR Oil and Gas West Asia Conference, Muscat, Oman, Mar. 31-Apr. 2, 2012.

Some other scientists have reported an increase in oil recovery through experiments involving carbonate cores using Advanced Ion Management (AIMSM), where it adds or removes different ions from the injected water. For example, low-salinity waterflood experiments were conducted on different carbonate cores. See Gupta et al. “Enhanced Waterflood for Middle East Carbonate Cores-Impact of Injection Water Composition,” SPE 142668, presented at the SPE Middle East Oil and Gas Show and Conference, Manama, Bahrain, Sept. 25-28, 2011. In that study, carbonate cores were used for both coreflooding and spontaneous imbibition experiments at 70° C. Synthetic brine was mixed with distilled water in four ways (diluted twice, 5 times, 10 times, and 100 times). From these experiments, it was reported an increase of 16-21% in oil recovery from spontaneous imbibition experiments. Additional scientists performed several low-salinity waterflood experiments using carbonate cores. See Al-Harrasi et al. “Laboratory Investigation of Low-salinity Waterflooding for Carbonate Reservoirs,” SPE 161468, presented at the Abu Dhabi International Petroleum Exhibition & Conference, Abu Dhabi, UAE, 11-14 Nov. 11-14, 2012. Carbonates cores were used during both coreflooding and spontaneous imbibition experiments at 70° C. Synthetic brine was mixed with distilled water in four ways making varying concentrations. From these experiments, an increase of 16-21% in oil recovery with coreflooding and spontaneous imbibitions was reported. See Al-Harrasi et al. (2012).

An additional study reported contact angle change with time with low-salinity brine, both on limestone and sandstone cores from oil reservoirs in Libya. Zekri, A. Y. et al., “Effect of EOR Technology on Wettability and Oil Recovery of Carbonate and Sandstone Formation. IPTC 14131,” presented at the International Petroleum Technology Conference, Bangkok, Thailand, Feb. 7-9, 2012. Several brine injection concentrations were used in the experiment to examine the effect of salinity in oil recovery by varying sulfate concentrations. The study concluded that wettability alteration is the main mechanism to increase recovery in carbonate formations by low-salinity water flooding. Others have experimental results showing improved oil recovery during low-salinity waterflood in carbonate reservoirs. Their experiments were conducted with live oil both at ambient and high temperatures (90° C.). Zahid et al. “Experimental Studies of Low-salinity Water Flooding Carbonate: A New Promising Approach,” SPE 155625, presented at the SPE EOR Conference at Oil and Gas West Asia, Muscat, Oman, Apr. 16-18, 2012. It was also observed no effect of low-salinity waterflooding on oil recovery at ambient temperature. However, an increase in oil recovery was observed with runs at high temperatures (90° C.). Moreover, due to the increase in pressure drop, migration of fines or dissolution effects may have occurred and may contribute to the increase in oil recovery.

Surfactant-augmented waterflooding to mobilize residual oil saturation has been applied in both carbonate and sandstone reservoirs. Residual oil mobilization with surfactant flooding is believed to be mainly due to reduction in IFT and wettability alteration towards hydrophilic state. The main technical challenges in surfactant flooding EOR are—(i) surfactant adsorption onto rock grain surfaces, (ii) high temperature, and (iii) high-salinity environments.

Hydrocarbon and non-hydrocarbon gas injection in general, and gas floods in particular, is the leading EOR flooding process in light-oil and medium-oil, both in sandstone and carbonate reservoirs.

### SUMMARY OF THE INVENTION

Low-salinity water alternate gas EOR can be applied to improve recovery of conventional water-alternate-gas (WAG) CO₂ by taking advantage the synergetic effect of both low-salinity EOR and CO₂ flooding EOR processes. After high-salinity waterflood, the present invention utilizes low-salinity water, surfactant diluted in low-salinity water, and gas injections in an alternating scheme to effectively mobilize additional residual oil in oil-wet carbonate reservoirs. The embodiment may be particularly useful when the high-salinity waterflood uses seawater in offshore environment.

The present invention relates to a method to enhance oil recovery using a surfactant-augmented, low-salinity waterflood, and a gas or gas mixture. The surfactant-augmented low-salinity water is utilized following a high-salinity water injection and at least one low-salinity water injection in the oil reservoir. Following the low-salinity waterflood, the present invention utilizes a surfactant diluted in low-salinity water. In some embodiments, low-salinity waterflooding and the surfactant diluted in low-salinity water injections may be alternated into the reservoir to effectively mobilize additional residual oil reservoirs.

Oil production and ultimately oil recovery is improved by injecting low-salinity water into an oil reservoir that has previously undergone a high-salinity water injection. However, both the production rate and ultimate oil recovery can be improved further by injecting surfactant-augmented low-salinity water after the low-salinity water injection and by injecting a gas into the reservoir following the injection of the surfactant-augmented low-salinity water. Any suitable surfactant may be used, but preferably the surfactant is non-ionic, such as an ethoxylated alcohol, at low concentrations (e.g., about 500 ppm to about 5,000 ppm). Non-ionic surfactants perform well in low-salinity brine and mobilize substantial residual oil when the low-salinity water is followed by surfactant diluted in low-salinity water. A suitable gas includes, but is not limited to, carbon dioxide.

A nonionic surfactant used in the presence of a moderate salinity water increases oil recovery in carbonate reservoirs. However, reservoirs are usually high saline environments. During seawater flooding, the salinity of reservoirs decreases but not low enough to be favorable for surfactant flooding. Due to this fact, the success of chemical EOR in general and a nonionic surfactant for field application has been limited. The seawater flooding will reduce the salinity of the reservoir formation water but will not be favorable enough for surfactant flooding yet; but low-salinity waterflood may further reduce the salinity to be favorable for ethoxylated alcohol surfactant flooding.

An advantage of the present invention is that the salinity of the environment will be lowered due to the low-salinity waterflood prior to the surfactant augmented low-salinity water flooding, especially when the waterflood uses a high-salinity water, such as seawater, in offshore environment. Low-salinity water injected into carbonate reservoirs, which have undergone seawater injection for water flooding, may produce additional oil more economically if a surfactant, (by way of example only, a low-concentration non-ionic surfactant), is added to the low-salinity water and injected as chase fluid. Thus, the surfactant will be effective in mobilizing residual oil.

Following the surfactant-augmented low-salinity flood, gas or gas mixture is injected. The low-salinity water, surfactant diluted in low-salinity water, gas injection sequence will be repeated in an alternating scheme. Thus, the process may be referred to as LSS-WAG.

By way of example, this EOR process, for example, can be applied to one of the largest carbonate reservoir, Upper Zakkum, located offshore Abu Dhabi. This reservoir is currently undergoing seawater flooding at injection rate of 800 MBW/day. The average daily oil production is 560 MSTB. LSS-WACO₂ EOR process can be beneficial to improve oil recovery of the field.

Injecting low-salinity water in carbonate reservoirs after waterflood, can produce substantial amount of remaining oil more economically if the low-salinity water is followed by non-ionic surfactant, followed by gas injection, which may be for example, CO₂. The low-salinity brine, surfactant, gas interjection sequence will be repeated similar to the classical water alternate gas (WAG) scheme.

While not wanting to be bound by theory, the inventors believe that the reason this process produces a great amount of remaining oil is because of favorable phase behavior which includes:
i. Low-salinity brine improves wettability towards water-wet condition and make the environment favorable for surfactant flooding to be effective;
ii. Surfactant (specifically, non-ionic surfactant) in low-salinity water solubilizes some of the remaining oil via Winsor type II⁻ microemulsion and lowers IFT between oil and water;
iii. The gas will follow surfactant to solubilize more of the remaining oil in the wettability-improved condition.
iv. The above three steps are repeated in alternate scheme; and they are following waterflood.

The present invention takes advantage of the synergistic effect of mobilizing residual oil due to low-salinity water, surfactant diluted in low-salinity water, and gas or gas mixture solvents.

An aspect of the invention is a method to enhance recovery of a hydrocarbon in a reservoir. The method includes waterflooding the reservoir with high-salinity water, then injecting low-salinity water into the reservoir. At least about 0.1 of a pore volume of the reservoir is occupied by the low-salinity water. A surfactant diluted in an additional low-salinity water is injected into the reservoir, where at least about 0.1 of the pore volume of the reservoir is occupied by the surfactant diluted in the additional low-salinity water. A gas is then injected into the reservoir, where at least about 0.1 of the pore volume of the reservoir is occupied by the gas. Then alternating injections of the low-salinity water into the reservoir, the surfactant diluted in the additional low-salinity water into the reservoir, and the gas into the reservoir are injected into the reservoir.

An aspect of the invention is a method to enhance oil recovery from a hydrocarbon reservoir. The method includes injecting high-salinity water into the reservoir. Low-salinity water is injected into the reservoir following the injection of the high-salinity water. The salinity level of the low-salinity water is less than a salinity level of the high-salinity water. Next, lower salinity water is injected into the reservoir following the injection of the low-salinity water. The salinity level of the lower salinity water is less than the salinity of the low-salinity water. A surfactant diluted in the lower salinity water is then injected into the reservoir and a gas is injected into the reservoir following the injection of the surfactant diluted in the lower salinity water. Alternating injections of the low-salinity water, the injection surfactant diluted in the lower salinity water and the gas injection are injected into the reservoir.

An aspect of the invention is a method to enhance recovery of oil in a hydrocarbon reservoir. The method includes injecting low-salinity water into the reservoir. A surfactant diluted in an additional low-salinity water is injected into the reservoir, where the salinity of the additional low-salinity water is less than or equal to a salinity of the low-salinity water. A gas is then injected into the reservoir after the injection of the surfactant diluted in the additional low-salinity water.

### BRIEF DESCRIPTION OF THE DRAWING

FIG. 1 illustrates the petrophysical model of a reservoir showing gamma ray, porosity, and permeability log for three formations;

FIG. 2 illustrates the photomicrographs of both lithofacies—Facies-5 (F5) Lithocodium-Bacinalla boundstone with inter- and intraparticle macro- to micropores, and Facies-6 (F6) Rudist wackstone with dolomitic burrow;

FIG. 3 illustrates idealized Paleo-bathymetric profile showing the interpreted environments of deposition as well as depositional water energy of reservoir and non-reservoir lithofacies Facies-1 (F1) to Facies-8 (F8) (Jobe, 2013); Facies-5 (F5) and Facies-6 (F6) are lithofacies used in this study; the abundance of bioclastic material present in lithofacies Facies-5 and indicates that a slightly shallower position relative to lithofacies Facies-6 as discussed in Jobe (2013);

FIG. 4 illustrates the pore size distribution of both Facies-5 and Facies-6

FIG. 5 illustrates the contact angle measurement of both Facies-5 and Facies-6 when the surrounding brines are SW, LS₁, LS₂, LS₃, and Deionized Water (DI);

FIG. 6 illustrates the contact angle measurement of both Facies-5 and Facies-6 when the surrounding brines of variable salinity+1000 ppm surfactant fluids are A-F;

FIG. 7 illustrates the contact angle measurements for Facies-5 at measurement conditions A, B, C, and D;

FIG. 8(a) illustrates cleaned un-aged core slices/discs (top) and crude-aged core slices (bottom). The rectangular shapes are Facies-5 carbonate core slices, while the circular shapes are Berea sandstone core discs;

FIG. 8(b) illustrate cleaned un-aged core discs, and core plug from Three Forks formation;

FIG. 9 illustrates the process steps of the coreflood experiments;

FIG. 10 illustrates the coreflood setup schematic;

FIG. 11 illustrates four short cores stacked together to form an about 8.614 inch long and about 49.205 cc total pore volume composite core;

FIG. 12 illustrates the oil recovery factor (RF) and pressure difference between injection and production end (ΔP, psia) as a function pore volume injected (PV inj) of the first coreflood;

FIG. 13 illustrates the core samples at completion of experiment 2; and

FIG. 14 illustrates RF and pressure difference between injection and production end (ΔP, psia) as a function pore volume injected.

### DETAILED DESCRIPTION

The present invention relates to methods to recover oil from a reservoir. An aspect of the invention relates to a method to recover oil from a reservoir, which includes injecting high-salinity water into the reservoir followed by alternating the injection of low-salinity water, surfactant diluted in low-salinity water and a gas or gas mixture. Another aspect of the invention includes a method for the enhanced recovery of oil from a reservoir where oil had previously been recovered.

As provided herein, the abbreviations as used within this patent application has the following meanings:

“High-salinity water” means a higher salinity level in water compared to a salinity level in low-salinity water. By way of example only, high-salinity water may be seawater, formation water, produced water and combinations thereof. High-salinity water also includes within its definition the term waterflooding as it is generally known in the art as in typical operations. “Low-salinity water” means water with a lower salinity level compared to the salinity level in a high-salinity water. By way of example only, high-salinity water may be seawater, while low-salinity water may be desalinated seawater. Other examples of low-salinity water may include, but are not limited to, at least one of desalinated seawater, diluted seawater, desalinated hydrocarbon reservoir formation water, diluted hydrocarbon reservoir water, river water, lake water, or formation water. Alternatively, low-salinity water may be seawater, while high-salinity water may be water with a higher salinity than the seawater. Thus, high-salinity water is defined by the comparison to the low-salinity water, and vice versa.
“LS₂” generally means low-salinity where the salinity level is lower than the high-salinity water (for example the seawater) by a factor of about 4. This low-salinity water can be prepared by a dilution or desalination processes.
“LS₃” generally means low-salinity where the salinity level is lower than the high-salinity water (for example the seawater) by a factor of about 50. This low-salinity water can be prepared by a dilution or desalination processes.
“LSₓ” generally means low-salinity where the salinity level is lower than the high-salinity water (for example the seawater) by a factor of about “y” (where y may be equal to x). This low-salinity water can be prepared by a dilution or desalination processes.
“PV” generally means pore volume.
“SW” generally means seawater.
“IFT” generally means interfacial tension.
“TDS” generally means total dissolved solids.
“Water cut” generally means the percentage or fraction of water compared to the oil produced during production.

One skilled in the art would understand that the operating conditions of the reservoir will depend upon the characteristics of the reservoir. Thus, the temperature, flow rate of the high-salinity water, flow rate of the low-salinity water, flow rate of the gas, the flow rate of the surfactant diluted in the low-salinity water, duration of the high-salinity waterflood, duration of the low-salinity waterflood, duration of the gas injection, or the duration of the surfactant diluted in the low-salinity water injection (each of which may be measured by the pore volume injected), the water cut and other operating parameters may not be discussed. However, one skilled in the art would understand how to determine the operating parameters for a particular reservoir.

An aspect of the present invention is a method to enhance the recovery of oil in a hydrocarbon reservoir. The method includes injecting low-salinity water into the reservoir followed by an injection of surfactant diluted in low-salinity water, wherein the salinity of low-salinity water of the surfactant diluted in the low-salinity water is at most the salinity of the low-salinity water. A gas is then injected into the reservoir. In some embodiments, the low-salinity water injection, the injection of the surfactant diluted in the low-salinity water, and the gas injection may be repeated in an alternating pattern (i.e. low-salinity water, surfactant diluted in low-salinity water, gas, low-salinity water, surfactant diluted in low-salinity water, gas, etc).

The method may further include a high-salinity waterflood prior to the low-salinity water injection. The salinity of the high-salinity water may be between about 35,000 ppm and about 60,000 ppm TDS, in some embodiments between about 40,000 ppm and about 50,000 ppm TDS, in some embodiments between about 40,000 ppm and about 100,000 ppm or even higher TDS (about 300,000 ppm).

The low-salinity water may be high-salinity water that has been desalinated or diluted. Furthermore, the low-salinity water may be further diluted and injected into the reservoir following an injection with low-salinity water. This lower-salinity water injection may be followed with a low-salinity water injection where the salinity level may be the same as a prior low-salinity water injection, or lower than a previous low-salinity water injection. By way of non-limiting example, the low-salinity water may be at least one of desalinated seawater, diluted seawater, desalinated hydrocarbon reservoir formation water, diluted hydrocarbon reservoir water, river water, lake water, or produced hydrocarbon reservoir water. In some embodiments, the salinity of a subsequent low-salinity water flood may have a salinity level that may be within about 75% of the salinity level of a prior low-salinity flood. Low-salinity waterflooding may be repeated until the water cut may be about 60% or more, about 80% or more, about 90% or more, about 95% or more.

The surfactant may be added to low-salinity water. By way of example, the surfactant may be diluted in low-salinity water that may have the same or lower salinity level as a prior injection of the low-salinity water. In some embodiments, the low-salinity water injection and the surfactant diluted in the additional low-salinity water may be alternated.

In some embodiments, the method may further include an injection of lower-salinity water following the low-salinity water injection. The salinity of the lower-salinity water may be less than the salinity of the low-salinity water. The method may further include alternating the injection of the lower-salinity water, the surfactant diluted in the lower-salinity water and the gas injections. The alternation of the lower salinity water injection, the injection of the surfactant diluted in the lower-salinity water and the gas injection may be repeated until the water cut may be greater than about 60%, greater than about 65%, greater than about 70%, greater than about 75%, greater than about 80%, greater than about 85%, greater than about 90% and greater than about 95%. Alternatively, the alternation of the lower salinity water injections and the surfactant diluted in the lower-salinity water injections and the gas injections may be repeated until the incremental oil recovery may be less than about 50%, about 40%, about 30%, about 20%, about 10%, or about 5%.

In some embodiments, the alternation pattern may be altered. Thus, the alternation pattern may be the low-salinity water, then the surfactant diluted in low-salinity water, then the gas injection. In some embodiments, the alternation pattern may be the gas injection, then the low-salinity water, then the surfactant diluted in the low-salinity water. Other combinations may be used and would be understood by one skilled in the art. In some embodiments, all three injections need not be repeated. By way of example only, in some embodiments the alternation pattern may be alternating the low-salinity water and the gas injections following the first injections of the low-salinity water, the surfactant diluted in the low-salinity water and the gas injections. In another example, the alternation pattern may be alternating the low-salinity water and the surfactant diluted in the low-salinity water.

The surfactant may be any suitable surfactant. Surfactants are surface-acting agents that reduce the interfacial tension (IFT) between brine and oil. Surfactants are classified according the ionic nature of the head group as anionic, cationic, and non-ionic. Anionic surfactants are mostly used in enhanced oil recovery for sandstone reservoirs. Suitable anionic include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. Non-ionic surfactants serve as co surfactants in order to improve the system phase behavior. Due to a better tolerance of non-ionic surfactant to salinity, anionic and non-ionic surfactants are sometimes used as a mixture of surfactants to enhance oil recovery. Carbonate reservoirs are usually oil-wet reservoirs, hence the recovery during seawater flooding is not efficient and requires surface-acting agents to alter the wettability and improve oil recovery. Cationic surfactants are sometimes used in carbonate reservoirs to alter wettability, but they are costly.

In some embodiments, the surfactant may be a nonionic surfactant. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol, polypropylene glycol, or a poloxamer. The nonionic surfactant may preferably be ethoxylated alcohol, which may applicable to reservoir conditions.

The concentration of the surfactant in low-salinity water (where the salinity level of the low-salinity water may be the same or less than the salinity level of a prior low-salinity water injection) may be between about 500 ppm to 10,000 ppm, in some embodiments between about 1,000 ppm and about 5,000 ppm. The concentration of the surfactant in the low-salinity water may be about 500 ppm, about 1,000 ppm, about 1,500 ppm, about 2,000 ppm, about 2,500 ppm, about 3,000 ppm, about 3,500 ppm, about 4,000 ppm, about 4,500 ppm, or about 5,000 ppm.

As described in the definitions, the salinity level of the low-salinity water is less than the salinity level of the high-salinity water. The low-salinity water may be formed by decreasing the salinity level of the high-salinity water to form the low-salinity water. By way of example the high-salinity water may be decreased by desalinating the high-salinity water. In some embodiments, the salinity level of the low-salinity water can be half the salinity level of the high-salinity water. In some embodiments, the salinity level of the low-salinity water can be twenty-five percent of the salinity level of the high-salinity water. In some embodiments, the low-salinity water can be “x” times the salinity level of the high-salinity water, where x is the amount the salinity is decreased compared to the high-salinity water. The benefits of the present invention may be increased when the salinity in the low-salinity water is decreased. Thus, in a preferred embodiment, the low-salinity water may be fresh water, though it is understood that the use of fresh water may be constricted by economic factors. Furthermore, the salinity of the low-salinity water may be the same or altered with each subsequent injection. Thus, by way of example only, the salinity level of the first low-salinity water injection may be about LS₂, which the salinity level of the second low-salinity water injection may be LS₃, then the salinity of the third low-salinity water injection may be LS₄.

The pore volume of the reservoir may be occupied by the low-salinity water injected into the reservoir, subsequent low-salinity water injections, or injections of the surfactant diluted in the low-salinity water, may be dependent upon the reservoir. In some embodiments, the pore volume of the reservoir occupied by the low-salinity water injected into the reservoir, subsequent low-salinity water injections, or injections of the surfactant diluted in the low-salinity water into the reservoir, may be about 1 (i.e. about 100%). In some embodiments, the pore volume of the reservoir occupied by the low-salinity water injected into the reservoir, subsequent low-salinity water injections, or injections of the surfactant diluted in the low-salinity water may be greater than about 0.1, about 0.2, about 0.3, about 0.4, about 0.5, about 0.6, about 0.7, about 0.8, about 0.9 or about 1. Furthermore, in some embodiments, the injections may be repeated such that the total pore volume of the injections exceeds 1. In some embodiments, the pore volume of the first low-salinity water injection may be less than or equal to the pore volume of subsequent low-salinity water injections (including low-salinity water injections with surfactant). In some embodiments where the high-salinity water was injected first, the pore volume of the reservoir of the low-salinity water may be about 1, such that the majority or all of the high-salinity water that was injected into the reservoir may be displaced by the low-salinity water. In some embodiments, the pore volume of the first surfactant diluted in low-salinity water injection may be higher than the pore volume of subsequent surfactant diluted in low-salinity water injections. In some embodiments, the pore volume of the first surfactant diluted in low-salinity water injection may be the same or less than the pore volume of subsequent surfactant diluted in low-salinity water injections. In some embodiments, the pore volume of the surfactant diluted in low-salinity water may be the same or different from the low-salinity water injections.

The gas can be any suitable gas, including but not limited to, carbon dioxide, natural gas liquids, liquid petroleum gas, nitrogen gas, and combinations thereof. The natural gas liquids can be intermediate hydrocarbons, such as C₂-C₅ gas, and combinations thereof. Liquefied petroleum gas (LPG) can be C₃ (propane) or C₄ (butane) or combinations thereof. Preferably, the gas may be carbon dioxide or NGLs. More preferably, the gas may be carbon dioxide. In some embodiments, at least some of the natural gas liquid or at least some of the LPG may be recycled from the reservoir. One skilled in the art would understand that the recycled natural gas may need to be scrubbed to remove any condensate or water within the gas prior to injection into the reservoir.

In some embodiments, the pore volume of the reservoir may be occupied by the gas, such that the gas may occupy greater than about 0, about 0.1, about 0.2, about 0.3, about 0.4, about 0.5, about 0.6, about 0.7, about 0.8, about 0.9 or about 1. In some embodiments, the pore volume of the first gas injection may be higher than the pore volume of subsequent gas injections. In some embodiments, the pore volume of the first gas injection may be the same or less than the pore volume of subsequent gas injections. Furthermore, in some embodiments, the gas injection may be repeated such that the total pore volume of the gas injections exceeds 1.

A slug size or slug may be used to characterize the relationship between the low-salinity water injection and surfactant diluted in low-salinity water, the low-salinity water and the gas, or the surfactant diluted in the low-salinity water and the gas injections. By way of example, the slug may be defined as a pore volume of the surfactant diluted in low-salinity water injected. The slug may be lower than about 0.1 PV. In some embodiments, the slug may be between 0.1 PV to about 1 PV, in some embodiments, between about 0.1 PV to about 0.5 PV. In some embodiments, the slug can be alternated in a slug size of about 0.5 pore volume. In some embodiments, a particular injection of the low-salinity water, the surfactant diluted in the low-salinity water, or the gas may be alternated in a slug size of about 0.1 to about 1 pore volume.

The method may be used to recover oil from an oil reservoir. In some embodiments, the oil reservoir may be an oil-wet carbonate reservoir, a shale reservoir or a sandstone reservoir. One skilled in the art would understand that the reservoir may comprise a single reservoir or multiple reservoirs, or a single well or multiple wells. The reservoir may be offshore or onshore.

The alternating injections may be continued for any duration, for example, until the water cut is at least about 80%. In some embodiments, the water cut can be about 85%, about 90%, and about 95%. In some embodiments, the operation cost may permit or prevent feasibility of the project. The oil recovered may be at least crude oil or natural gas.

An aspect of the present invention is a method to enhance oil recovery from a hydrocarbon reservoir. The method includes injecting high-salinity water into the reservoir, then injecting low-salinity water into the reservoir following the injection of the high-salinity water. The salinity level of the low-salinity water is less than a salinity level of the high-salinity water. Lower salinity water can be injected into the reservoir following the injection of the low-salinity water. The salinity level of the lower salinity water is less than the salinity of the low-salinity water. A surfactant diluted in the lower salinity water into the reservoir is then injected into the reservoir. A gas is then injected into the reservoir. Then, injections of the low-salinity water, the surfactant diluted in the low-salinity water and the gas are injected into the reservoir in an alternating manner.

The salinity of the high-salinity water may be between about 35,000 ppm and about 60,000 ppm TDS, in some embodiments between about 40,000 ppm and about 50,000 ppm TDS, in some embodiments between about 40,000 ppm and about 100,000 ppm or even higher TDS (about 300,000 ppm)

The low-salinity water may be high-salinity water that has been desalinated or diluted. Furthermore, the low-salinity water may be further diluted and injected into the reservoir following an injection with low-salinity water. This lower-salinity water injection may be followed with a low-salinity water injection where the salinity level may be the same as a prior low-salinity water injection, or lower than a previous low-salinity water injection. By way of non-limiting example, the low-salinity water may be at least one of desalinated seawater, diluted seawater, desalinated hydrocarbon reservoir formation water, diluted hydrocarbon reservoir water, river water, lake water, or produced hydrocarbon reservoir water. In some embodiments, the salinity of a subsequent low-salinity water flood may have a salinity level that may be within about 75% of the salinity level of a prior low-salinity flood. Low-salinity waterflooding may be repeated until the water cut may be about 60% or more, about 80% or more, about 90% or more, about 95% or more.

The surfactant may be added to low-salinity water. By way of example, the surfactant may be diluted in low-salinity water that may have the same or lower salinity level as a prior injection of the low-salinity water. In some embodiments, the low-salinity water injection and the surfactant diluted in the additional low-salinity water may be alternated.

In some embodiments, the method may further include an injection of lower-salinity water following the low-salinity water injection. The salinity of the lower-salinity water may be less than the salinity of the low-salinity water. The method may further include alternating the injection of the lower-salinity water, the surfactant diluted in the lower-salinity water and the gas injections. The alternation of the lower salinity water injection, the injection of the surfactant diluted in the lower-salinity water and the gas injection may be repeated until the water cut may be greater than about 60%, greater than about 65%, greater than about 70%, greater than about 75%, greater than about 80%, greater than about 85%, greater than about 90% and greater than about 95%. Alternatively, the alternation of the lower salinity water injections and the surfactant diluted in the lower-salinity water injections and the gas injections may be repeated until the incremental oil recovery may be less than about 50%, about 40%, about 30%, about 20%, about 10%, or about 5%.

In some embodiments, the alternation pattern may be altered. Thus, the alternation pattern may be the low-salinity water, then the surfactant diluted in low-salinity water, then the gas injection. In some embodiments, the alternation pattern may be the gas injection, then the low-salinity water, then the surfactant diluted in the low-salinity water. Other combinations may be used and would be understood by one skilled in the art. In some embodiments, all three injections need not be repeated. By way of example only, in some embodiments the alternation pattern may be alternating the low-salinity water and the gas injections following the first injections of the low-salinity water, the surfactant diluted in the low-salinity water and the gas injections. In another example, the alternation pattern may be alternating the low-salinity water and the surfactant diluted in the low-salinity water.

The surfactant may be any suitable surfactant. Surfactants are surface-acting agents that reduce the interfacial tension (IFT) between brine and oil. Surfactants are classified according the ionic nature of the head group as anionic, cationic, and non-ionic. Anionic surfactants are mostly used in enhanced oil recovery for sandstone reservoirs. Suitable anionic include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. Non-ionic surfactants serve as co surfactants in order to improve the system phase behavior. Due to a better tolerance of non-ionic surfactant to salinity, anionic and non-ionic surfactants are sometimes used as a mixture of surfactants to enhance oil recovery. Carbonate reservoirs are usually oil-wet reservoirs, hence the recovery during seawater flooding is not efficient and requires surface-acting agents to alter the wettability and improve oil recovery. Cationic surfactants are sometimes used in carbonate reservoirs to alter wettability, but they are costly.

In some embodiments, the surfactant may be a nonionic surfactant. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol, polypropylene glycol, or a poloxamer. The nonionic surfactant may preferably be ethoxylated alcohol, which may applicable to reservoir conditions.

The concentration of the surfactant in low-salinity water (where the salinity level of the low-salinity water may be the same or less than the salinity level of a prior low-salinity water injection) may be between about 500 ppm to 10,000 ppm, in some embodiments between about 1,000 ppm and about 5,000 ppm. The concentration of the surfactant in the low-salinity water may be about 1,000 ppm, about 1,500 ppm, about 2,000 ppm, about 2,500 ppm, about 3,000 ppm, about 3,500 ppm, about 4,000 ppm, about 4,500 ppm, or about 5,000 ppm.

As described in the definitions, the salinity level of the low-salinity water is less than the salinity level of the high-salinity water. The low-salinity water may be formed by decreasing the salinity level of the high-salinity water to form the low-salinity water. By way of example the high-salinity water may be decreased by desalinating the high-salinity water. In some embodiments, the salinity level of the low-salinity water can be half the salinity level of the high-salinity water. In some embodiments, the salinity level of the low-salinity water can be twenty-five percent of the salinity level of the high-salinity water. In some embodiments, the low-salinity water can be “x” times the salinity level of the high-salinity water, where x is the amount the salinity is decreased compared to the high-salinity water. The benefits of the present invention may be increased when the salinity in the low-salinity water is decreased. Thus, in a preferred embodiment, the low-salinity water may be fresh water, though it is understood that the use of fresh water may be constricted by economic factors. Furthermore, the salinity of the low-salinity water may be the same or altered with each subsequent injection. Thus, by way of example only, the salinity level of the first low-salinity water injection may be about LS₂, which the salinity level of the second low-salinity water injection may be LS₃, then the salinity of the third low-salinity water injection may be LS₄.

The pore volume of the reservoir may be occupied by the low-salinity water injected into the reservoir, subsequent low-salinity water injections, or injections of the surfactant diluted in the low-salinity water, may be dependent upon the reservoir. In some embodiments, the pore volume of the reservoir occupied by the low-salinity water injected into the reservoir, subsequent low-salinity water injections, or injections of the surfactant diluted in the low-salinity water into the reservoir, may be about 1 (i.e. about 100%). In some embodiments, the pore volume of the reservoir occupied by the low-salinity water injected into the reservoir, subsequent low-salinity water injections, or injections of the surfactant diluted in the low-salinity water may be greater than about 0.1, about 0.2, about 0.3, about 0.4, about 0.5, about 0.6, about 0.7, about 0.8, about 0.9 or about 1. Furthermore, in some embodiments, the injections may be repeated such that the total pore volume of the injections exceeds 1. In some embodiments, the pore volume of the first low-salinity water injection may be less than or equal to the pore volume of subsequent low-salinity water injections (including low-salinity water injections with surfactant). In some embodiments where the high-salinity water was injected first, the pore volume of the reservoir of the low-salinity water may be about 1, such that the majority or all of the high-salinity water that was injected into the reservoir may be displaced by the low-salinity water. In some embodiments, the pore volume of the first surfactant diluted in low-salinity water injection may be higher than the pore volume of subsequent surfactant diluted in low-salinity water injections. In some embodiments, the pore volume of the first surfactant diluted in low-salinity water injection may be the same or less than the pore volume of subsequent surfactant diluted in low-salinity water injections. In some embodiments, the pore volume of the surfactant diluted in low-salinity water may be the same or different from the low-salinity water injections.

The gas can be any suitable gas, including but not limited to, carbon dioxide, natural gas liquids, liquid petroleum gas, nitrogen gas, and combinations thereof. The natural gas liquids can be intermediate hydrocarbons, such as C₂-C₅ gas, and combinations thereof. Liquefied petroleum gas (LPG) can be C₃ (propane) or C₄ (butane) or combinations thereof. Preferably, the gas may be carbon dioxide or NGLs. More preferably, the gas may be carbon dioxide. In some embodiments, at least some of the natural gas liquid or at least some of the LPG may be recycled from the reservoir. One skilled in the art would understand that the recycled natural gas may need to be scrubbed to remove any condensate or water within the gas prior to injection into the reservoir.

In some embodiments, the pore volume of the reservoir may be occupied by the gas, such that the gas may occupy greater than about 0, about 0.1, about 0.2, about 0.3, about 0.4, about 0.5, about 0.6, about 0.7, about 0.8, about 0.9 or about 1. In some embodiments, the pore volume of the first gas injection may be higher than the pore volume of subsequent gas injections. In some embodiments, the pore volume of the first gas injection may be the same or less than the pore volume of subsequent gas injections. Furthermore, in some embodiments, the gas injection may be repeated such that the total pore volume of the gas injections exceeds 1.

A slug size or slug may be used to characterize the relationship between the low-salinity water injection and surfactant diluted in low-salinity water, the low-salinity water and the gas, or the surfactant diluted in the low-salinity water and the gas injections. By way of example, the slug may be defined as a pore volume of the surfactant diluted in low-salinity water injected. The slug may be lower than about 0.1 PV. In some embodiments, the slug may be between 0.1 PV to about 1 PV, in some embodiments, between about 0.1 PV to about 0.5 PV. In some embodiments, the slug can be alternated in a slug size of about 0.5 pore volume. In some embodiments, a particular injection of the low-salinity water, the surfactant diluted in the low-salinity water, or the gas may be alternated in a slug size of about 0.1 to about 1 pore volume.

The method may be used to recover oil from an oil reservoir. In some embodiments, the oil reservoir may be an oil-wet carbonate reservoir, a shale reservoir or a sandstone reservoir. One skilled in the art would understand that the reservoir may comprise a single reservoir or multiple reservoirs, or a single well or multiple wells. The reservoir may be offshore or onshore.

The alternating injections may be continued for any duration, for example, until the water cut is at least about 80 mass %. In some embodiments, the water cut can be about 85 mass %, about 90 mass %, and about 95 mass %. In some embodiments, the operation cost may permit or prevent feasibility of the project. The oil recovered may be at least crude oil or natural gas.

An aspect of the present invention includes an enhance recovery of a hydrocarbon in a reservoir. The method includes waterflooding the reservoir with high-salinity water. The high-salinity waterflood is followed by an injection of low-salinity water into the reservoir. A pore volume of at least about 0.2 is occupied by the low-salinity water. A surfactant diluted in low-salinity water is injected into the reservoir following the low-salinity water injection. The pore volume of at least about 0.2 is occupied by the surfactant diluted in the additional low-salinity water. A gas is then injected into the reservoir. Injections of the low-salinity water injection, the surfactant diluted in the low-salinity water, and the gas may be alternated.

The salinity of the high-salinity water may be between about 35,000 ppm and about 60,000 ppm TDS, in some embodiments between about 40,000 ppm and about 50,000 ppm TDS, in some embodiments between about 40,000 ppm and about 100,000 ppm or even higher TDS (about 300,000 ppm).

The low-salinity water may be high-salinity water that has been desalinated or diluted. Furthermore, the low-salinity water may be further diluted and injected into the reservoir following an injection with low-salinity water. This lower-salinity water injection may be followed with a low-salinity water injection where the salinity level may be the same as a prior low-salinity water injection, or lower than a previous low-salinity water injection. By way of non-limiting example, the low-salinity water may be at least one of desalinated seawater, diluted seawater, desalinated hydrocarbon reservoir formation water, diluted hydrocarbon reservoir water, river water, lake water, or produced hydrocarbon reservoir water. In some embodiments, the salinity of a subsequent low-salinity water flood may have a salinity level that may be within about 75% of the salinity level of a prior low-salinity flood. Low-salinity waterflooding may be repeated until the water cut may be about 60% or more, about 80% or more, about 90% or more, about 95% or more.

The surfactant may be added to low-salinity water. By way of example, the surfactant may be diluted in low-salinity water that may have the same or lower salinity level as a prior injection of the low-salinity water. In some embodiments, the low-salinity water injection and the surfactant diluted in the additional low-salinity water may be alternated.

In some embodiments, the method may further include an injection of lower-salinity water following the low-salinity water injection. The salinity of the lower-salinity water may be less than the salinity of the low-salinity water. The method may further include alternating the injection of the lower-salinity water, the surfactant diluted in the lower-salinity water and the gas injections. The alternation of the lower salinity water injection, the injection of the surfactant diluted in the lower-salinity water and the gas injection may be repeated until the water cut may be greater than about 60%, greater than about 65%, greater than about 70%, greater than about 75%, greater than about 80%, greater than about 85%, greater than about 90% and greater than about 95%. Alternatively, the alternation of the lower salinity water injections and the surfactant diluted in the lower-salinity water injections and the gas injections may be repeated until the incremental oil recovery may be less than about 50%, about 40%, about 30%, about 20%, about 10%, or about 5%.

In some embodiments, the alternation pattern may be altered. Thus, the alternation pattern may be the low-salinity water, then the surfactant diluted in low-salinity water, then the gas injection. In some embodiments, the alternation pattern may be the gas injection, then the low-salinity water, then the surfactant diluted in the low-salinity water. Other combinations may be used and would be understood by one skilled in the art. In some embodiments, all three injections need not be repeated. By way of example only, in some embodiments the alternation pattern may be alternating the low-salinity water and the gas injections following the first injections of the low-salinity water, the surfactant diluted in the low-salinity water and the gas injections. In another example, the alternation pattern may be alternating the low-salinity water and the surfactant diluted in the low-salinity water.

The surfactant may be any suitable surfactant. Surfactants are surface-acting agents that reduce the interfacial tension (IFT) between brine and oil. Surfactants are classified according the ionic nature of the head group as anionic, cationic, and non-ionic. Anionic surfactants are mostly used in enhanced oil recovery for sandstone reservoirs. Suitable anionic include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. Non-ionic surfactants serve as co surfactants in order to improve the system phase behavior. Due to a better tolerance of non-ionic surfactant to salinity, anionic and non-ionic surfactants are sometimes used as a mixture of surfactants to enhance oil recovery. Carbonate reservoirs are usually oil-wet reservoirs, hence the recovery during seawater flooding is not efficient and requires surface-acting agents to alter the wettability and improve oil recovery. Cationic surfactants are sometimes used in carbonate reservoirs to alter wettability, but they are costly.

In some embodiments, the surfactant may be a nonionic surfactant. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol, polypropylene glycol, or a poloxamer. The nonionic surfactant may preferably be ethoxylated alcohol, which may applicable to reservoir conditions.

The concentration of the surfactant in low-salinity water (where the salinity level of the low-salinity water may be the same or less than the salinity level of a prior low-salinity water injection) may be between about 500 ppm to 10,000 ppm, in some embodiments between about 1,000 ppm and about 5,000 ppm. The concentration of the surfactant in the low-salinity water may be about 1,000 ppm, about 1,500 ppm, about 2,000 ppm, about 2,500 ppm, about 3,000 ppm, about 3,500 ppm, about 4,000 ppm, about 4,500 ppm, or about 5,000 ppm.

As described in the definitions, the salinity level of the low-salinity water is less than the salinity level of the high-salinity water. The low-salinity water may be formed by decreasing the salinity level of the high-salinity water to form the low-salinity water. By way of example the high-salinity water may be decreased by desalinating the high-salinity water. In some embodiments, the salinity level of the low-salinity water can be half the salinity level of the high-salinity water. In some embodiments, the salinity level of the low-salinity water can be twenty-five percent of the salinity level of the high-salinity water. In some embodiments, the low-salinity water can be “x” times the salinity level of the high-salinity water, where x is the amount the salinity is decreased compared to the high-salinity water. The benefits of the present invention may be increased when the salinity in the low-salinity water is decreased. Thus, in a preferred embodiment, the low-salinity water may be fresh water, though it is understood that the use of fresh water may be constricted by economic factors. Furthermore, the salinity of the low-salinity water may be the same or altered with each subsequent injection. Thus, by way of example only, the salinity level of the first low-salinity water injection may be about LS₂, which the salinity level of the second low-salinity water injection may be LS₃, then the salinity of the third low-salinity water injection may be LS₄.

The pore volume of the reservoir may be occupied by the low-salinity water injected into the reservoir, subsequent low-salinity water injections, or injections of the surfactant diluted in the low-salinity water, may be dependent upon the reservoir. In some embodiments, the pore volume of the reservoir occupied by the low-salinity water injected into the reservoir, subsequent low-salinity water injections, or injections of the surfactant diluted in the low-salinity water into the reservoir, may be about 1 (i.e. about 100%). In some embodiments, the pore volume of the reservoir occupied by the low-salinity water injected into the reservoir, subsequent low-salinity water injections, or injections of the surfactant diluted in the low-salinity water may be greater than about 0.1, about 0.2, about 0.3, about 0.4, about 0.5, about 0.6, about 0.7, about 0.8, about 0.9 or about 1. Furthermore, in some embodiments, the injections may be repeated such that the total pore volume of the injections exceeds 1. In some embodiments, the pore volume of the first low-salinity water injection may be less than or equal to the pore volume of subsequent low-salinity water injections (including low-salinity water injections with surfactant). In some embodiments where the high-salinity water was injected first, the pore volume of the reservoir of the low-salinity water may be about 1, such that the majority or all of the high-salinity water that was injected into the reservoir may be displaced by the low-salinity water. In some embodiments, the pore volume of the first surfactant diluted in low-salinity water injection may be higher than the pore volume of subsequent surfactant diluted in low-salinity water injections. In some embodiments, the pore volume of the first surfactant diluted in low-salinity water injection may be the same or less than the pore volume of subsequent surfactant diluted in low-salinity water injections. In some embodiments, the pore volume of the surfactant diluted in low-salinity water may be the same or different from the low-salinity water injections.

The gas can be any suitable gas, including but not limited to, carbon dioxide, natural gas liquids, liquid petroleum gas, nitrogen gas, and combinations thereof. The natural gas liquids can be intermediate hydrocarbons, such as C₂-C₅ gas, and combinations thereof. Liquefied petroleum gas (LPG) can be C₃ (propane) or C₄ (butane) or combinations thereof. Preferably, the gas may be carbon dioxide or NGLs. More preferably, the gas may be carbon dioxide. In some embodiments, at least some of the natural gas liquid or at least some of the LPG may be recycled from the reservoir. One skilled in the art would understand that the recycled natural gas may need to be scrubbed to remove any condensate or water within the gas prior to injection into the reservoir.

In some embodiments, the pore volume of the reservoir may be occupied by the gas, such that the gas may occupy greater than about 0, about 0.1, about 0.2, about 0.3, about 0.4, about 0.5, about 0.6, about 0.7, about 0.8, about 0.9 or about 1. In some embodiments, the pore volume of the first gas injection may be higher than the pore volume of subsequent gas injections. In some embodiments, the pore volume of the first gas injection may be the same or less than the pore volume of subsequent gas injections. Furthermore, in some embodiments, the gas injection may be repeated such that the total pore volume of the gas injections exceeds 1.

A slug size or slug may be used to characterize the relationship between the low-salinity water injection and surfactant diluted in low-salinity water, the low-salinity water and the gas, or the surfactant diluted in the low-salinity water and the gas injections. By way of example, the slug may be defined as a pore volume of the surfactant diluted in low-salinity water injected. The slug may be lower than about 0.1 PV. In some embodiments, the slug may be between 0.1 PV to about 1 PV, in some embodiments, between about 0.1 PV to about 0.5 PV. In some embodiments, the slug can be alternated in a slug size of about 0.5 pore volume. In some embodiments, a particular injection of the low-salinity water, the surfactant diluted in the low-salinity water, or the gas may be alternated in a slug size of about 0.1 to about 1 pore volume.

The method may be used to recover oil from an oil reservoir. In some embodiments, the oil reservoir may be an oil-wet carbonate reservoir, a shale reservoir or a sandstone reservoir. One skilled in the art would understand that the reservoir may comprise a single reservoir or multiple reservoirs, or a single well or multiple wells. The reservoir may be offshore or onshore.

The alternating injections may be continued for any duration, for example, until the water cut is at least about 80%. In some embodiments, the water cut can be about 85%, about 90%, and about 95%. In some embodiments, the operation cost may permit or prevent feasibility of the project. The oil recovered may be at least crude oil or natural gas.

An aspect of the present invention is a method to enhance the recovery of oil from a reservoir. The method includes injecting seawater into the oil reservoir. The salinity of the seawater is between about 35,000 ppm to about 60,000 ppm TDS. The seawater flood is followed by a low-salinity water injection into the reservoir. The salinity of the low-salinity water is at most about one half of the salinity of the seawater. The lower-salinity water injection follows the low-salinity waterflood. The salinity of the lower-salinity water is at most about a quarter of the salinity of the seawater. Following the lower salinity waterflood, the reservoir is flooded with a surfactant diluted in the lower-salinity water. A gas is then injected into the reservoir. The lower-salinity flooding and the surfactant diluted in the lower-salinity water, and gas injections are alternated until a water cut is greater than about 60%.

The salinity of the seawater water may be between about 35,000 ppm and about 60,000 ppm TDS, in some embodiments between about 40,000 ppm and about 50,000 ppm TDS, in some embodiments between about 40,000 ppm and about 100,000 ppm or even higher TDS (about 300,000 ppm).

The low-salinity water may be seawater water that has been desalinated or diluted. Furthermore, the low-salinity water may be further diluted and injected into the reservoir following an injection with low-salinity water. This lower-salinity water injection may be followed with a low-salinity water injection where the salinity level may be the same as a prior low-salinity water injection, or lower than a previous low-salinity water injection. By way of non-limiting example, the low-salinity water may be at least one of desalinated seawater, diluted seawater, desalinated hydrocarbon reservoir formation water, diluted hydrocarbon reservoir water, river water, lake water, or produced hydrocarbon reservoir water. In some embodiments, the salinity of a subsequent low-salinity water flood may have a salinity level that may be within about 75% of the salinity level of a prior low-salinity flood. Low-salinity waterflooding may be repeated until the yield of oil from the reservoir may be less than about 40%, less than about 35%, less than about 30%, less than about 25%, less than about 20%, less than about 15%, less than about 10% or less than about 5%.

The surfactant may be added to low-salinity water. By way of example, the surfactant may be diluted in low-salinity water that may have the same or lower salinity level as a prior injection of the low-salinity water. In some embodiments, the low-salinity water injection and the surfactant diluted in the additional low-salinity water may be alternated.

In some embodiments, the method may further include an injection of lower-salinity water following the low-salinity water injection. The salinity of the lower-salinity water may be less than the salinity of the low-salinity water. The method may further include alternating the injection of the lower-salinity water, the surfactant diluted in the lower-salinity water and the gas injections. The alternation of the lower salinity water injection, the injection of the surfactant diluted in the lower-salinity water and the gas injection may be repeated until the water cut may be greater than about 60%, greater than about 65%, greater than about 70%, greater than about 75%, greater than about 80%, greater than about 85%, greater than about 90% and greater than about 95%. Alternatively, the alternation of the lower salinity water injections and the surfactant diluted in the lower-salinity water injections and the gas injections may be repeated until the incremental oil recovery may be less than about 50%, about 40%, about 30%, about 20%, about 10%, or about 5%.

In some embodiments, the alternation pattern may be altered. Thus, the alternation pattern may be the low-salinity water, then the surfactant diluted in low-salinity water, then the gas injection. In some embodiments, the alternation pattern may be the gas injection, then the low-salinity water, then the surfactant diluted in the low-salinity water. Other combinations may be used and would be understood by one skilled in the art. In some embodiments, all three injections need not be repeated. By way of example only, in some embodiments the alternation pattern may be alternating the low-salinity water and the gas injections following the first injections of the low-salinity water, the surfactant diluted in the low-salinity water and the gas injections. In another example, the alternation pattern may be alternating the low-salinity water and the surfactant diluted in the low-salinity water.

The surfactant may be any suitable surfactant. Surfactants are surface-acting agents that reduce the interfacial tension (IFT) between brine and oil. Surfactants are classified according the ionic nature of the head group as anionic, cationic, and non-ionic. Anionic surfactants are mostly used in enhanced oil recovery for sandstone reservoirs. Suitable anionic include, but are not limited to, surfactants that include sulfonate or a sulfonate group, such as sodium laureth sulfate, ammonium lauryl sulfate, dioctyl sodium sulfosuccinate, perfluorobutanesulfonic acid, perfluorononanoic acid, perfluorooctanesulfonic acid, perfluorooctanoic acid, potassium lauryl sulfate, sodium dodecyl sulfate, sodium dodecyl benzene sulfonate, sodium lauroyl sarcosinate, sodium myreth sulfate, sodium pareth sulfate, sodium stearate, soaps, alkyl sulfate, alkyl ether sulfates, sulfated alkanolamides, glyceride sulfates, dodecyl benzene sulfonate, alpha olefin sulfonates, lignosulfonates, the like and combinations thereof. Non-ionic surfactants serve as co surfactants in order to improve the system phase behavior. Due to a better tolerance of non-ionic surfactant to salinity, anionic and non-ionic surfactants are sometimes used as a mixture of surfactants to enhance oil recovery. Carbonate reservoirs are usually oil-wet reservoirs, hence the recovery during seawater flooding is not efficient and requires surface-acting agents to alter the wettability and improve oil recovery. Cationic surfactants are sometimes used in carbonate reservoirs to alter wettability, but they are costly.

In some embodiments, the surfactant may be a nonionic surfactant. The nonionic surfactant can be at least one of ethoxylated alcohol, polyoxyethylene glycol alkyl ether, octaethylene glycol monododecyl ether, pentaethylene glycol monododecyl ether, polyoxypropylene glycol alkyl ether, glucoside alkyl ether, decyl glucoside, lauryl glucoside, octyl glucoside, polyoxyethylene glycol octylphenol ether, triton X-100, polyoxyethylene glycol alkylphenol ether, nonoxynol-9, glycerol alkyl esters, glyceryl laurate, polyoxyethylene glycol sorbitan alkyl esters, polysorbate, sorbitan alkyl esters, spans, cocamide MEA, cocamide DEA, dodecyldimethylamine oxide, block copolymers of polyethylene glycol, polypropylene glycol, or a poloxamer. The nonionic surfactant may preferably be ethoxylated alcohol, which may applicable to reservoir conditions.

The concentration of the surfactant in low-salinity water (where the salinity level of the low-salinity water may be the same or less than the salinity level of a prior low-salinity water injection) may be between about 500 ppm to 10,000 ppm, in some embodiments between about 1,000 ppm and about 5,000 ppm. The concentration of the surfactant in the low-salinity water may be about 1,000 ppm, about 1,500 ppm, about 2,000 ppm, about 2,500 ppm, about 3,000 ppm, about 3,500 ppm, about 4,000 ppm, about 4,500 ppm, or about 5,000 ppm.

As described in the definitions, the salinity level of the low-salinity water is less than the salinity level of the seawater water. The low-salinity water may be formed by decreasing the salinity level of the seawater water to form the low-salinity water. By way of example the seawater water may be decreased by desalinating the seawater water. In some embodiments, the salinity level of the low-salinity water can be half the salinity level of the seawater water. In some embodiments, the salinity level of the low-salinity water can be twenty-five percent of the salinity level of the seawater water. In some embodiments, the low-salinity water can be “x” times the salinity level of the seawater water, where x is the amount the salinity is decreased compared to the seawater water. The benefits of the present invention may be increased when the salinity in the low-salinity water is decreased. Thus, in a preferred embodiment, the low-salinity water may be fresh water, though it is understood that the use of fresh water may be constricted by economic factors. Furthermore, the salinity of the low-salinity water may be the same or altered with each subsequent injection. Thus, by way of example only, the salinity level of the first low-salinity water injection may be about LS₂, which the salinity level of the second low-salinity water injection may be LS₃, then the salinity of the third low-salinity water injection may be LS₄.

The pore volume of the reservoir may be occupied by the low-salinity water injected into the reservoir, subsequent low-salinity water injections, or injections of the surfactant diluted in the low-salinity water, may be dependent upon the reservoir. In some embodiments, the pore volume of the reservoir occupied by the low-salinity water injected into the reservoir, subsequent low-salinity water injections, or injections of the surfactant diluted in the low-salinity water into the reservoir, may be about 1 (i.e. about 100%). In some embodiments, the pore volume of the reservoir occupied by the low-salinity water injected into the reservoir, subsequent low-salinity water injections, or injections of the surfactant diluted in the low-salinity water may be greater than about 0.1, about 0.2, about 0.3, about 0.4, about 0.5, about 0.6, about 0.7, about 0.8, about 0.9 or about 1. Furthermore, in some embodiments, the injections may be repeated such that the total pore volume of the injections exceeds 1. In some embodiments, the pore volume of the first low-salinity water injection may be less than or equal to the pore volume of subsequent low-salinity water injections (including low-salinity water injections with surfactant). In some embodiments where the seawater was injected first, the pore volume of the reservoir of the low-salinity water may be about 1, such that the majority or all of the seawater that was injected into the reservoir may be displaced by the low-salinity water. In some embodiments, the pore volume of the first surfactant diluted in low-salinity water injection may be higher than the pore volume of subsequent surfactant diluted in low-salinity water injections. In some embodiments, the pore volume of the first surfactant diluted in low-salinity water injection may be the same or less than the pore volume of subsequent surfactant diluted in low-salinity water injections. In some embodiments, the pore volume of the surfactant diluted in low-salinity water may be the same or different from the low-salinity water injections.

The gas can be any suitable gas, including but not limited to, carbon dioxide, natural gas liquids, liquid petroleum gas, nitrogen gas, and combinations thereof. The natural gas liquids can be intermediate hydrocarbons, such as C₂-C₅ gas, and combinations thereof. Liquefied petroleum gas (LPG) can be C₃ (propane) or C₄ (butane) or combinations thereof. Preferably, the gas may be carbon dioxide or NGLs. More preferably, the gas may be carbon dioxide. In some embodiments, at least some of the natural gas liquid or at least some of the LPG may be recycled from the reservoir. One skilled in the art would understand that the recycled natural gas may need to be scrubbed to remove any condensate or water within the gas prior to injection into the reservoir.

In some embodiments, the pore volume of the reservoir may be occupied by the gas, such that the gas may occupy greater than about 0, about 0.1, about 0.2, about 0.3, about 0.4, about 0.5, about 0.6, about 0.7, about 0.8, about 0.9 or about 1. In some embodiments, the pore volume of the first gas injection may be higher than the pore volume of subsequent gas injections. In some embodiments, the pore volume of the first gas injection may be the same or less than the pore volume of subsequent gas injections. Furthermore, in some embodiments, the gas injection may be repeated such that the total pore volume of the gas injections exceeds 1.

A slug size or slug may be used to characterize the relationship between the low-salinity water injection and surfactant diluted in low-salinity water, the low-salinity water and the gas, or the surfactant diluted in the low-salinity water and the gas injections. By way of example, the slug may be defined as a pore volume of the surfactant diluted in low-salinity water injected. The slug may be lower than about 0.1 PV. In some embodiments, the slug may be between 0.1 PV to about 1 PV, in some embodiments, between about 0.1 PV to about 0.5 PV. In some embodiments, the slug can be alternated in a slug size of about 0.5 pore volume. In some embodiments, a particular injection of the low-salinity water, the surfactant diluted in the low-salinity water, or the gas may be alternated in a slug size of about 0.1 to about 1 pore volume.

The method may be used to recover oil from an oil reservoir. In some embodiments, the oil reservoir may be an oil-wet carbonate reservoir, a shale reservoir or a sandstone reservoir. One skilled in the art would understand that the reservoir may comprise a single reservoir or multiple reservoirs, or a single well or multiple wells. The reservoir may be offshore or onshore.

The alternating injections may be continued for any duration, for example, until the water cut is at least about 80 mass %. In some embodiments, the water cut can be about 85 mass %, about 90 mass %, and about 95 mass %. In some embodiments, the operation cost may permit or prevent feasibility of the project. The oil recovered may be at least crude oil or natural gas.

### Examples

Coreflood, IFT, contact angle, and phase behavior measurements were performed to investigate the viability of the proposed EOR process. Significant oil recovery, favorable wettability alteration, and brine-oil IFT reduction was observed with the proposed EOR process. The following experiments describe fluid, core, equipment, and experimental results.

### Fluids

A 32° API crude oil from a carbonate reservoir in the Middle East (here after Reservoir I) is used in the experiments. It has a pH value of 6.5 and its viscosity is 3 cp at reservoir temperature of 195° F. Table 1 lists the composition of the reservoir oil. All of the values in Table 1 are approximate.

TABLE 1

| Component | Mole % |
|---|---|
| CO₂ | 1.05 |
| N₂ | 0.00 |
| C₁ | 13.78 |
| C₂ | 5.46 |
| C₃ | 6.58 |
| C₄* | 5.72 |
| C₅* | 5.27 |
| C₉* | 33.63 |
| C₂₁* | 21.94 |
| C₄₇* | 6.57 |

*Lumped components

The composition of synthetic seawater (SW) representative of the seawater in the Middle East, and low-salinity water (LS₁, LS₂ and LS₃) used in coreflood, IFT, and contact angle measurements are listed in Table 2. Reservoir I formation brine (FB) of ˜100,000 ppm salinity, and about 0.535 cp viscosity was used during core saturation.

TABLE 2

| Brine/ | | | | | |
|---|---|---|---|---|---|
| Component | | | | | |
| (kppm) | Na₂SO₄ | CaCₗ₂ | MgCl₂ | NaCl | TDS |
| SW | 4.891 | 1.915 | 13.55 | 30.99 | 51.346 |
| LS₁ | 2.446 | 0.958 | 6.775 | 15.5 | 25.679 |
| LS₂ | 1.223 | 0.479 | 3.388 | 7.75 | 12.84 |
| LS₃ | 0.098 | 0.038 | 0.271 | 0.62 | 1.027 |

A non-ionic surfactant, ethoxylated alcohol, with approximately 8 moles of ethylene oxide per mole of alcohol is used in the experiments. The cloud point, and phase behavior studies illustrate that the surfactant used is compatible with the reservoir conditions during low-salinity waterflood.

### Reservoir Cores

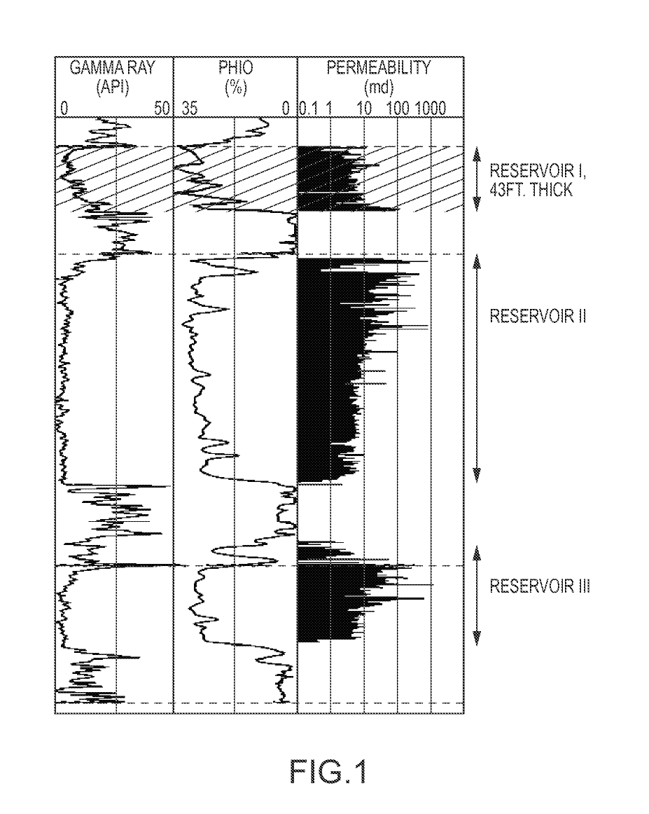

The cores used in the experiment are from Reservoir I. Reservoir I is the upper reservoir section of a giant carbonate field in the Middle East that comprises Reservoir I, II and III as illustrated in FIG. 1. Reservoir I has an average pay thickness of about 43 feet, average porosity of about 24%, and average permeability of about 1.5 md. The reservoir temperature and oil API gravity of Reservoir I is 195° F. and 32, respectively. The three reservoirs have a combined thickness of about 300 feet and currently they are undergoing water injection at 800 MB/day and oil production at 560 MSTB/day. Primary oil production began in 1983 with water injection started in 1984. The first water breakthrough occurred in 1991. Over the years, water cut has increased from 5% in the early 1990s to 24% in 2006. Currently, most of the oil production comes from Reservoir II and Reservoir III. Reservoir II and Reservoir III have higher permeability as compared to Reservoir I.

Recovery of Reservoir I can be improved by applying existing enhanced oil recovery (EOR) processes and additional improvement may be achieved by applying LSS-WACO₂ EOR process.

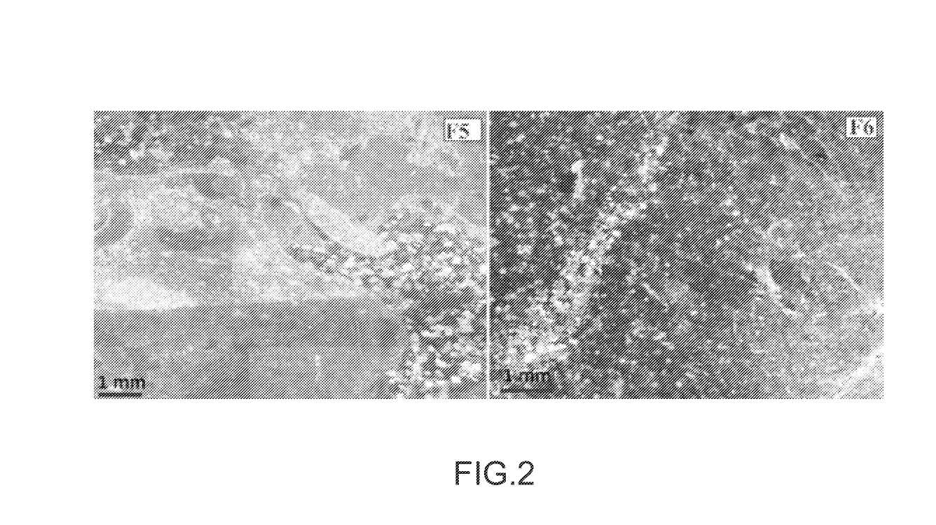

Facies-5 is heterogeneous with dominant micro/macro porosity, and the rock texture is Lithocodium-Bacinella boundstone. Abundant Lithocodium-Bacinella echinoderm, coral bivalve skeletal debris, and benthic forams are present in this facies. Facies-6 is Lithocodium-Bacinella wackestone with dolomitic burrows. Oncoidal Lithocodium-Bacinella, and benthic forams are abundant in this lithofacies. Facies-6, similar to Facies-5, has micro/macro/fracture dominant porosity. Both facies are dominantly calcite with only minor occurrences of dolomite, glauconite and pyrite. FIG. 2 illustrates the photomicrographs of both lithofacies—Facies-5 Lithocodium-Bacinalla boundstone with inter- and intraparticle macro- to micropores, and Facies-6 Rudist wackstone with dolomitic burrow (illustration from Jobe, “Sedimentology, Chemostratigraphy and Quantitative Pore Architecture in Microporous Carbonates: Example From A Giant Oil Field Offshore Abu Dhabi, U.A.E”, PhD Thesis, Geology Department, Colorado School of Mines (2013) (“Jobe (2013)”).

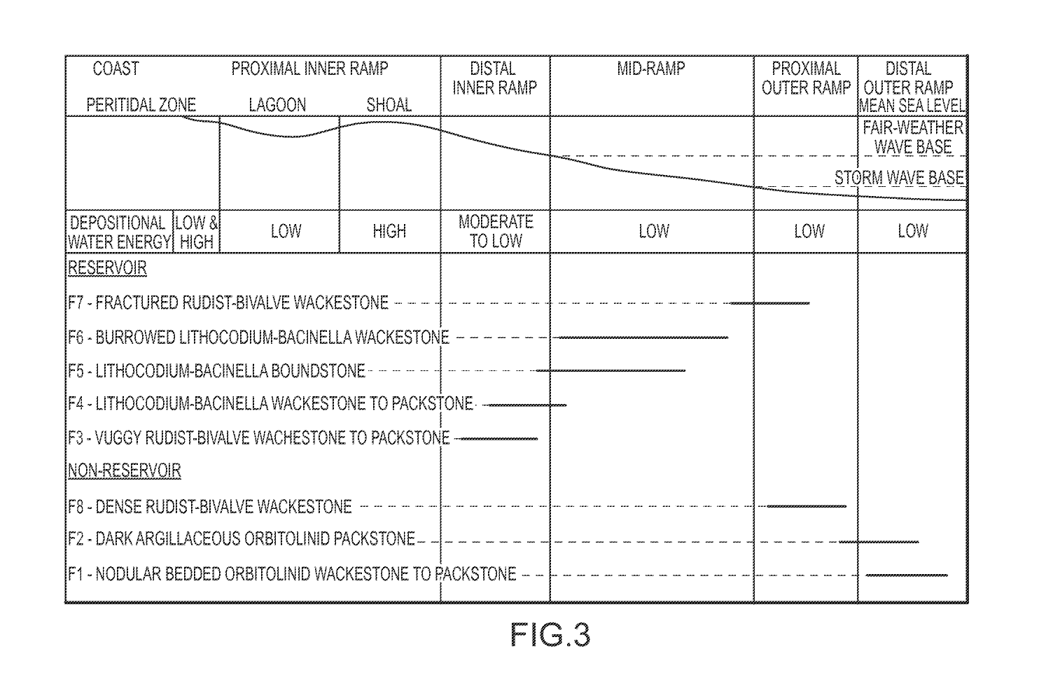

The fine grain size, abundance of mud and pervasive burrowing, indicates that both Facies-5 and Facies-6 were deposited within the photic zone. Both Facies-5 and Facies-6 are interpreted by Jobe (2013) as being deposited in a low energy open marine mid-ramp setting. The abundance of bioclastic material present in lithofacies Facies-5 indicates that a slightly shallower position relative to lithofacies Facies-6, as illustrated in FIG. 3 from Jobe (2013).

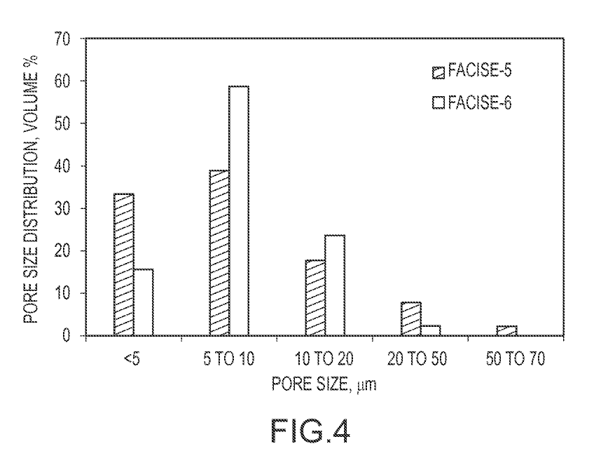

The pore size distribution of Facies-5 and Facies-6 are mainly about 5 to 10 μm with significant percentage below about 5 μm pore size. FIG. 4 (from Jobe (2013) illustrates the pore size distribution of both lithofacies.

The permeability, porosity, core dimensions, and other properties of the cores of Reservoir I used in the composite core flooding experiments are given in Table 3. Coreflooding measurements were performed on two facies of Reservoir I—Facies-5, and Facies-6. Core discs form adjacent core plugs of Facies-5 and Facies-6 were also used for contact angle measurements. The diameter for both samples was about 1.5 inches. The pore volume for experiment 1 was about 49.205 ml, and for experiment 2 the pore volume was about 32.587 ml. The k_{brine} for experiment 1 was about 0.39 md, and about 1.34 md for experiment 2.

TABLE 3

| Exp. # | Core Description | L (in) | φ, % | kₐᵢᵣ (md) |
|---|---|---|---|---|
| 1 | Composite of four | 1.643 | 26.94 | 3.38 |
| | Facies-5 carbonate | 3.255 | 24.6 | NA |
| | cores | 1.82 | 20.7 | 1.16 |
| | | 1.896 | 14.54 | 0.76 |
| 2 | Composite of three | 1.95 | 23.75 | 3.38 |
| | Facies-6 carbonate | 1.81 | 22.71 | 1.81 |
| | cores | 1.51 | 17.36 | 0.696 |

### Minimum Miscibility Pressure (MMP)

The minimum miscibility pressure (MMP) of the reservoir oil with CO₂ gas was measured using the Rising Bubble Apparatus (RBA). The MMP of the reservoir oil and CO₂ gas is 2,500 psia. The MMP of reservoir oil and CO₂ gas also calculated using the Multiple Mixing Cell (MMC) approach, and good agreement has been achieved with the experimental data. The MMP of Reservoir I oil with CO₂ gas is determined using MMC approach as 2,470 psia. Table 4 is the MMP of the crude oil with different injection gas scenarios.

TABLE 4

| Gas injection cases | MMP, psia |
|---|---|
| 100% CO₂ | 2470 |
| 100% NGLs* | 830 |
| 50% CO₂ and 50% NGLs* | 1615 |
| 100% N₂ | 14,000 |
| 50% N₂ and 50% NGLs* | 4860 |
| 20% N₂ and 80% NGLs* | 1400 |

*[0.61 C₂, 0.22 C₃, 0.095 C₄, 0.065 C₅ and 0.01 C₆] is the composition of NGLs used in this study.

### Contact Angle Measurements

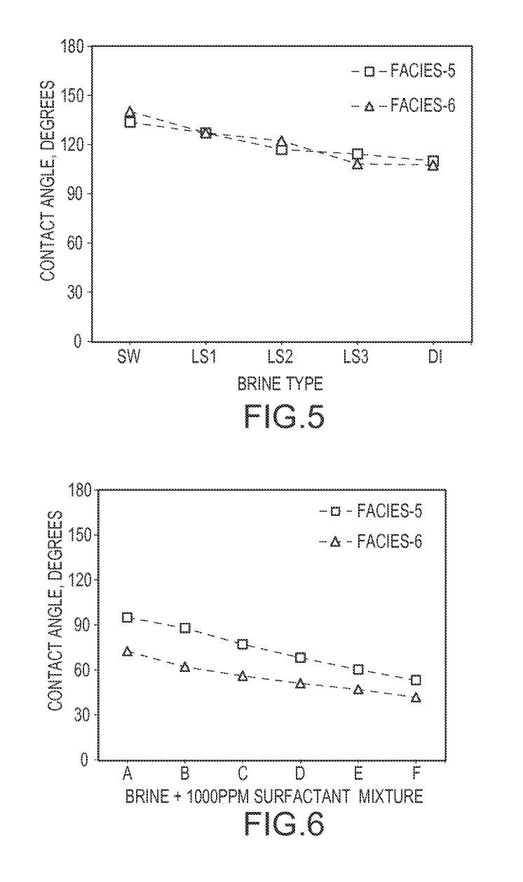

Contact angle (Θ) measurement between crude oil and aged Facies-5 and Facies-6 carbonate core discs from Reservoir I was measured using DSA 100 equipment. Captive oil droplet is the method of contact angle measurement type employed. The effect of low-salinity water, surfactant, and CO₂ on contact angle measurement was performed. FIG. 5 illustrates the contact angle measurement of both Facies-5 and Facies-6 when the surrounding brines are SW, LS₁, LS₂, LS₃, and Deionized Water (DI). There is no surfactant in these experiments. For both Facies-5 and Facies-6, a wettability alteration from oil-wet to intermediate-wet was observed with reduction in salinity of the surrounding brine. Three weeks aging for Facies-5 and eight weeks aging for Facies-5 were applied.

FIG. 6 and Table 5 illustrate the contact angle measurement of both Facies-5 and Facies-6 when the surrounding brines of variable salinity+1000 ppm surfactant fluids are “A” through “F”. Three weeks aging for Facies-5 and eight weeks aging for Facies-5 were applied. The oil droplet volumes for these experiments are between about 2 to 3 μl. The surfactant concentration was maintained at 1,000 ppm for samples A-F.

TABLE 5

| Brine with | | Facies-5 | | Facies-6 | |
|---|---|---|---|---|---|
| Surfactant | | Contact | Volume of | Contact | Volume of |
| | Salinity | Angle, θ | oil droplets | Angle, θ | oil droplets |
| Sample | (ppm) | (degrees) | (μl) | (degrees) | (μl) |
| A | 102,692 | 95.0 | 2.0 | 72.4 | 2.0 |
| B | 92,423 | 87.8 | 2.0 | 62.0 | 2.0 |
| C | 51,346 | 77.0 | 2.5 | 56.0 | 2.5 |
| D | 25,679 | 68.1 | 2.5 | 51.0 | 2.5 |
| E | 12,840 | 60.2 | 2.5 | 47.0 | 2.5 |
| F | ~0 | 53.1 | 3.0 | 41.7 | 3.0 |

To mimic the LSS-WACO₂ EOR process, additional contact angle measurements were performed at measurement conditions A, B, C, and D. Measurement condition A refers to a contact angle measurement on crude-aged core discs where the surrounding fluid is SW or SW+Surfactant (two separate measurements) with no CO₂; and Measurement condition D refers to a contact angle measurement of cleaned un-aged core discs where the surrounding brine is SW or SW+Surfactant, again with no CO₂. Measurement condition A and D represents two extreme situation of the LSS-WACO₂ EOR process—where “A” may refer when no EOR or only surfactant EOR is applied, and “D” may correspond to a situation where the LSS-WACO₂ EOR ‘cleaned’ the reservoir rock extremely and no residual oil is left behind. In measurement condition B, the core discs were submersed in seawater (SW) with and without 1,000 ppm surfactant solution (two separate experiments) of 300 ml in a high pressure cylinder vessel, then 200 ml CO₂ was added to the solution at 2,500 psia and kept the system for two days under high pressure. Hence, the fluid contained in the high pressure cylinder is SW+CO₂ or SW+Surfactant+CO₂. The 2,500 psia was chosen to achieve miscible situation between CO₂ and the oil used in aging the core discs. Then, the pressure was released; core discs were extracted; bleach resistant tissue papers were used to absorb any mobilized oil during the two day soaking under high pressure. Finally, captive droplet contact angle measurements were performed at surface conditions with the same fluids extracted from the cylinder as the surrounding environment. Measurement condition C is similar to measurement condition B, except LS₁+CO₂ instead of SW+CO₂; and LS₁+Surfactant+CO₂ instead of SW+Surfactant+CO₂ were used.

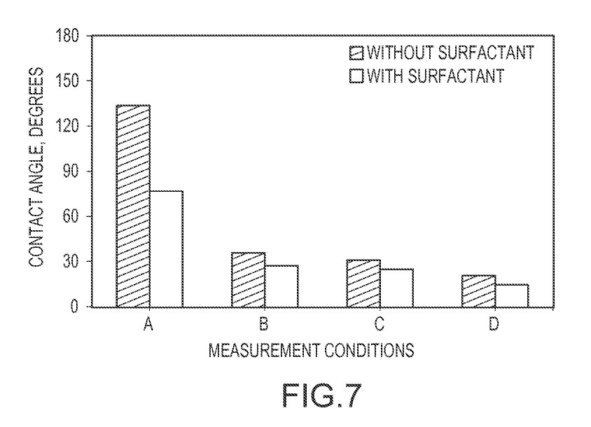

FIG. 7 illustrates the contact angle measurements for Facies-5 at measurement conditions B and C. Contact angles at measurement condition A and D are also included in the plot for comparison reasons. Measurement condition A refers to a contact angle measurement on crude-aged core discs where the surrounding fluid is SW or SW+Surfactant (two separate measurements) with no CO₂. Measurement condition D refers to a contact angle measurement of cleaned un-aged core discs where the surrounding brine is SW or SW+Surfactant, again with no CO₂. Measurement condition A and D represents two extreme situation of the proposed EOR process—where “A” may refer when no EOR or only surfactant EOR is applied, and “D” may correspond to a situation where the LSS-WACO₂ EOR ‘cleaned’ the reservoir rock extremely and no residual oil is left behind.

A slight contact angle reduction was observed between measurement conditions B and C, which can be attributed to the effect of low-salinity water in the proposed EOR. By comparing measurement conditions A and C, a significant wettability alteration occurs, and can be attributed to the oil mobilization by low-salinity-water-surfactant-alternate-CO₂ (LSS-WACO₂) EOR process.

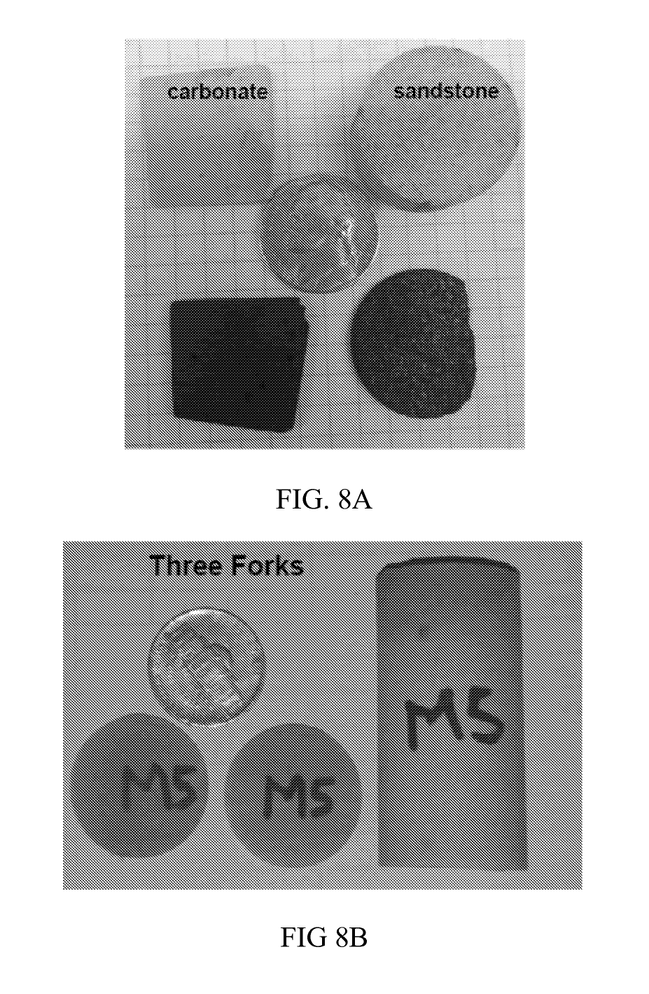

Contact angle measurement on a 65.4 md permeability and 17% porosity Berea sandstone and on ultra-low permeability unconventional reservoir core samples were also performed. The mineralogy of the Berea sandstone is mainly quartz. The unconventional core sample is from Three Forks carbonate mudstone formation in the Whilston Basin. The Three Forks core sample used is from a depth of 10,676.5 ft. The rock fabric of the Three Forks core is clay mottled siliceous dolomudstone. It has an effective permeability of 0.0144 md and porosity of 3.81%. The mineralogy analysis from QEMSCAN shows that it is 74% dolomite, 19.9% quartz, 3.2% Feldspars, 2.4% Clays, 0.2% Pyrite, and 0.3% other minerals. The major pore size contribution determined from mercury intrusion porosimetry (MIP) data is 0.7 μm. (Franklin Dykes, A., “Deposition, stratigraphy, provenance, and reservoir characterization of carbonate mudstones: the Three Forks Formation, Williston Basin,” PhD Thesis, Geology Department, Colorado School of Mines (2014)). FIG. 8(a) illustrates cleaned un-aged core slices/discs (top) and crude-aged core slices (bottom). The rectangular shapes are Facies-5 carbonate core slices, while the circular shapes are Berea sandstone core discs. FIG. 8(b) illustrate cleaned un-aged core discs, and core plug from Three Forks formation.

Similar contact angle results for the sandstone and Three Forks sample compared to the results of the crude-aged Facies-5 carbonate core were observed. Table 6 illustrates the contact angle measurements of the three core types at measurement conditions A, B, C and D.

TABLE 6

| | Contact Angle, θ (degrees) | | | | | |
|---|---|---|---|---|---|---|
| | Carbonate | | Berea Sandstone | | Three Forks | |
| | | With | | With | | With |
| Measurement | Without | 1000 ppm | Without | 1000 ppm | Without | 1000 ppm |
| Condition | surfactant | surfactant | surfactant | surfactant | surfactant | surfactant |
| A | 133.6 | 77.0 | 94.6 | NA | 116.6 | NA |
| B | 36.1 | 27.6 | 60.0 | 56.0 | 40.8 | 37.0 |
| C | 31.2 | 25.3 | 46.5 | 25.8 | 36.6 | 30.0 |
| D | 21.0 | 15.0 | 20.4 | NA | 27.0 | NA |

### Interfacial Tension Measurements

Interfacial tension (IFT) between brine and reservoir oil is measured using DSA 100 equipment. Pendant drop approach is used in measuring the IFT. Different brine mixtures were used, such as seawater (SW), seawater with 1,000 ppm non-ionic surfactant (SW+Surfactant), SW and CO₂ mixture (SW+CO₂) are discussed in Table 7. In the case of SW+CO₂ and LS₁+CO₂ mixtures, about 500 ml of brine and CO₂ mixture was kept in a cylinder at about 2,500 psia for two days, then the IFT measurement was performed at surface conditions. This IFT measurement may not be a representative of the brine-oil IFT reduction due to CO₂ at reservoir conditions, as most of the CO₂ were escaped during the IFT measurement. However, the measurement can be used as a qualitative indication. Further brine-oil IFT reduction may be achieved for a case of oil-brine-CO₂ system at high pressure and temperature. The pH of the system was also measured (and shown in Table 7). A pH reduction with the CO₂ was observed which indicates that the effect of CO₂ was not completely lost during the IFT measurement.

TABLE 7

| | IFT between oil and brine | |
|---|---|---|
| Fluid | (dynes/cm) | pH |
| SW | 16.62 | 6.60 |
| SW + CO₂ | 11.96 | 5.50 |
| SW + Surfactant | 4.14 | 7.94 |
| LS₁ | 18.85 | 6.53 |
| LS₁ + CO₂ | 12.34 | 5.29 |
| LS₁ + Surfactant | 4.54 | 7.82 |

### Coreflood Experimental Procedures:

Cores were prepared, cleaned using toluene and methanol. The reservoir oil and formation brine from Reservoir I was filtered at about 1 and about 0.5 microns, respectively. Viscosity values were measured at reservoir temperature of about 195° F. as about 3.0 cp and about 0.535 cp, respectively. Since the cores are tight (about 0.5 md to about 3.5 md, with average permeability about 1.5 md), ultra-high speed centrifuge was used to fully saturate the cores with formation brine. After the cores were saturated with formation brine using a high speed centrifuge or other method, the following core flooding procedure was performed:
i. Four or three short cores from the same lithofacies were stacked together to form a long composite core. Huppler technique (Huppler, 1969) was applied to minimize heterogeneity effects in forming composite cores.
ii. Cores were placed in the core holder, and confining pressure of 2,300 psia, back pressure of 1,800 psia, and reservoir temperature of 195° F., were applied to mimic the reservoir conditions.
iii. Formation brine was injected at an about 0.1 cc/min flow rate. This is to make sure that the core is still 100% saturated with brine and no air is trapped in the pores, also to determine the absolute permeability of the core to brine.
iv. Oil was then injected at an about 0.1 cc/min flow rate until connate water saturation (S_{wc}) is achieved. The oil relative permeability end point is determined at this step.
v. To restore wettability, eight weeks of aging was applied.
vi. Prior to sea water injection, about 4 pore volume (PV) oil was injected to mimic oil saturated reservoir condition.
vii. Seawater (SW) was injected to displace the oil at an about 0.1 cc/min flow rate. At this step, oil recovery during water flooding, and water relative permeability end point was determined.
viii. Produced fluids were collected in fraction collector, centrifuged, and volumetric measurements were performed.
ix. After establishing residual oil saturation to sea waterflood (S_{orw}), three sets low-salinity waterflood (LS₁, LS₂ and LS₃) at a rate of 0.1 cc/min were performed; 5 PV for each low-salinity waterfloods was injected. Table 2 illustrates the composition of seawater (SW) and the three sets of low-salinity water.
x. Produced fluids were collected in fraction collector (in each low-salinity flood sequences), centrifuged, and volumetric measurements were performed.
xi. Surfactant diluted in LS₂ coreflood experiment was performed at a rate of 0.1 cc/min. 5 PV of 1,000 ppm non-ionic surfactant diluted in LS₂ was used for the first coreflood experiment. 10 PV of 5,000 ppm non-ionic surfactant diluted in LS₂ was used for the second one.
xii. Produced fluids were collected in fraction collector, centrifuged, and volumetric measurements were performed.
xiii. Five to ten pore volume CO₂ flood at 0.3 cc/min was followed the surfactant flood. During the CO₂ flood, the confining pressure and back-pressure regulator were raised to 2,700 psia and 2,500 psia, respectively, to achieve miscibility. Because of the high pressure gas in the system, produced fluids were collected in high pressure cylinder; at the end of the CO₂ flood, the gas was slowly released through a gas flow meter (GFM); then the liquid (brine+oil) was extracted from the separator, centrifuged, and volumetric measurements were performed.

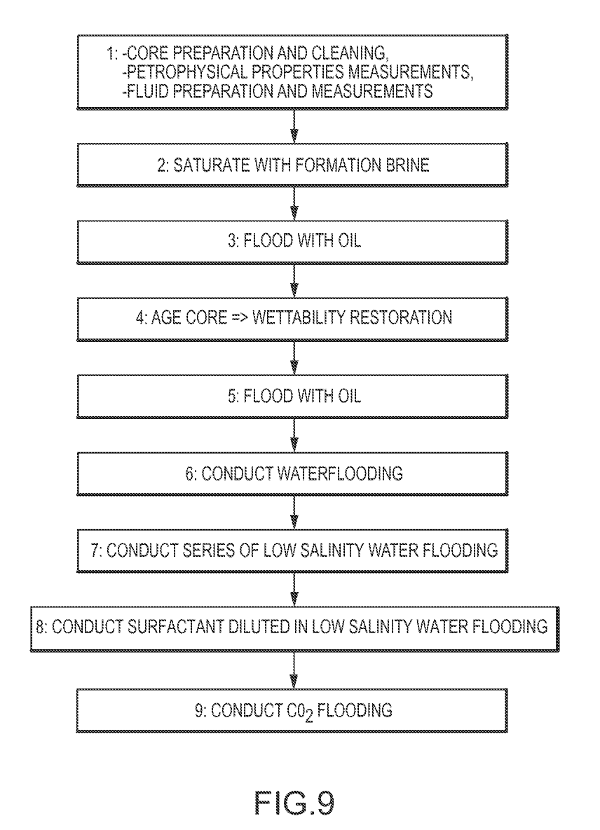

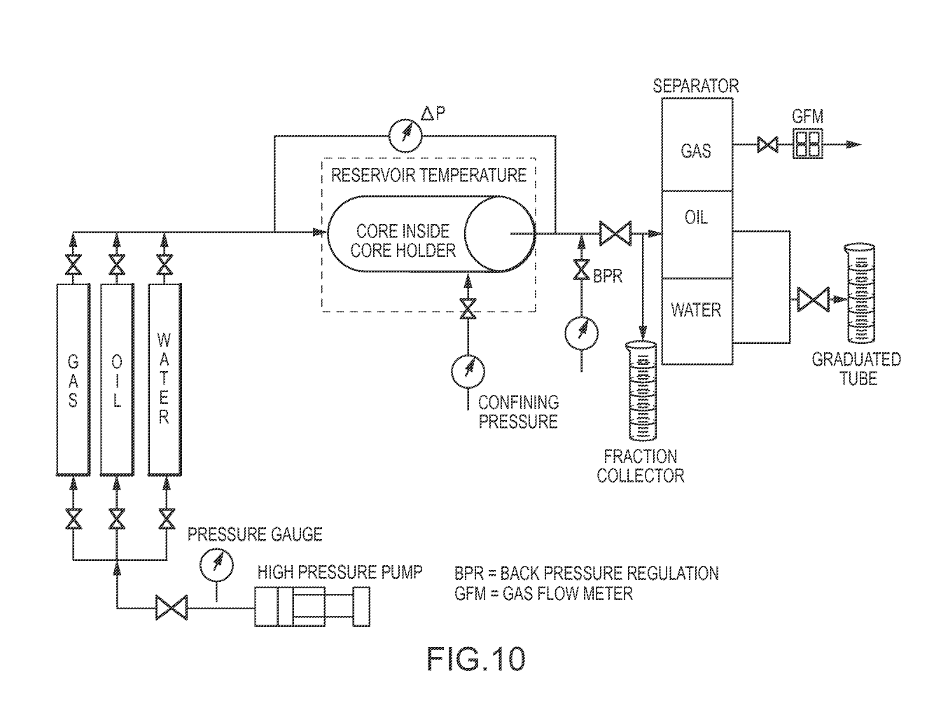

FIG. 9 illustrates the process steps of the coreflood experiments. The coreflood setup schematic is illustrated in FIG. 10. During seawater or low-salinity water flooding or surfactant flood, the production fluids are collected in fraction collector, centrifuged, and volumetric measurements were performed. During gas (CO₂) flooding, the separator is used to collect the production fluid. The produced gas was measured as it passes through the gas flow meter (GFM). The liquid (brine+oil) was extracted from the separator, centrifuged, and volumetric measurements were performed.

### Experiment 1

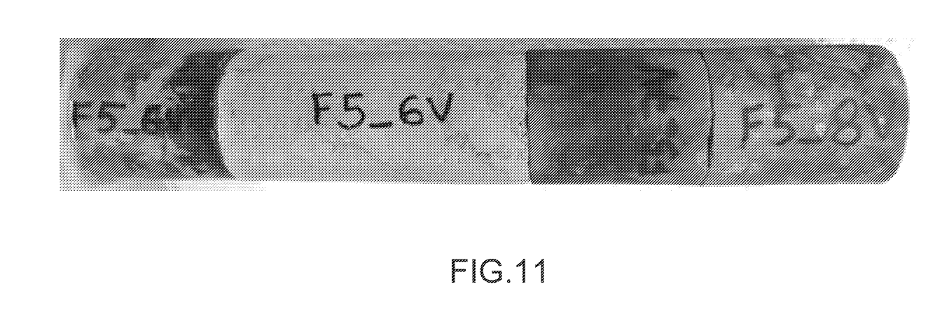

Four short cores were stacked together to form an about 8.614 inch long and about 49.205 cc total pore volume composite core (as illustrated in FIG. 11 and Table 3). The cores are from Reservoir I, Facies-5 carbonate formation. The images in FIG. 11 were taken after the cores were saturated with formation brine. The flooding direction is from left to right.

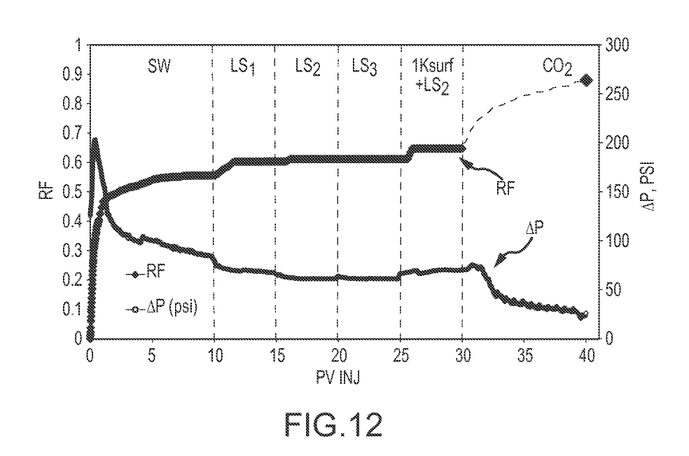

FIG. 12 illustrates the oil recovery factor (RF) and pressure difference between injection and production end (ΔP, psia) as a function pore volume injected (PV inj) of the first coreflood. During seawater (SW) flood, approximately 55.51% oil was recovered. A low-salinity water that has half salinity concentration compared to seawater (i.e. LS₁) flood resulted in an incremental oil recovery of up to about 4.77%. Another additional about 1.1% incremental recovery was observed during the second low-salinity waterflooding (LS₂). No additional recovery was obtained during the third low-salinity flood cycle (LS₃). The PV injected during SW flood was about 10 PV at about 0.1 cc/min rate of injection. About 5 PV injection at 0.1 cc/min was applied during each low-salinity water floods. The connate water saturation of this experiment was about 15.17%, and the residual oil saturation after producing oil using the series of SW and low-salinity water floods was about 38.9%. Thus, the overall sequence of the flood was about 10 PV SW injection, about 5 PV each LS₁, LS₂, LS₃, about 1000 ppm Surfactant+LS₂ (1Ksurf+LS₂) floods, and about 10 PV CO₂ flood.

Additional approximately 3.6% oil was recovered during 5 PV injection of about 1,000 ppm surfactant diluted in LS₂. The injection rate during this stage is also about 0.1 cc/min. As illustrated in FIG. 12 and Table 8, a minor pressure buildup was observed during this flooding sequence. At the start of the 1,000 ppm surfactant+LS₂ flood, the ΔP was 66 psia and increased to about 70 psia at the end of the surfactant flood. Thus, surfactant adsorption during the experiment was minimal.

TABLE 8

| | Coreflood Ex. 1 | | Coreflood Ex. 2 | |
|---|---|---|---|---|
| Flood Type | Cum. RF | ΔP, psi | Cum. RF | ΔP, psi |
| 10 PV, SW | 0.55 | 79.22 | 0.489 | 82.48 |
| 5 PV, LS₁ | 0.603 | 65.44 | 0.551 | 62.11 |
| 5 PV, LS₂ | 0.611 | 63.62 | 0.563 | 57.36 |
| 5 PV, LS₃ | 0.611 | 62.11 | 0.563 | 49.39 |
| 5 PV, 1000 ppm Surfactant + | 0.647 | 70.36 | NA | NA |
| LS₂ | | | | |
| 10 PV, 5000 ppm Surfactant + | NA | NA | 0.611 | 68.12 |
| LS₂ | | | | |
| 5 PV, CO₂ flood | NA | NA | 0.725 | 17.36 |
| 10 PV, CO2 flood | 0.88 | 25.99 | NA | NA |

Following the surfactant flood, additional 10 PV continuous miscible CO₂ flooding was performed at injection rate of 0.3 cc/min. Miscibility is achieved by increasing the back pressure regulator to 2,700 psia as mentioned in the experimental procedure section. Incremental oil recovery of 23.24% has been obtained during the miscible CO₂ flooding.

### Experiment 2

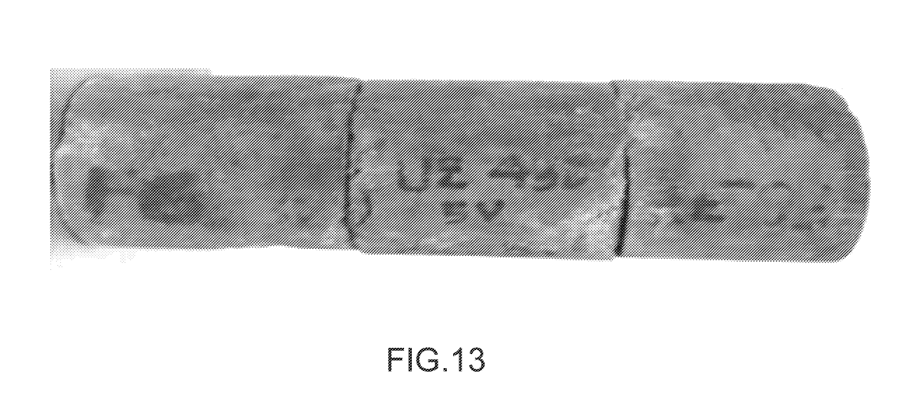

Similar flooding sequence was performed on a composite core made of three Facies-6 carbonate cores. The total pore volume of this composite core is about 32.587 cc, and the total length composite is about 5.27 inch. FIG. 13 illustrates three Facies-6 cores used in the experiment. The photo illustrated in FIG. 13 was taken at the end of the experiment. The flooding direction is from left to right.

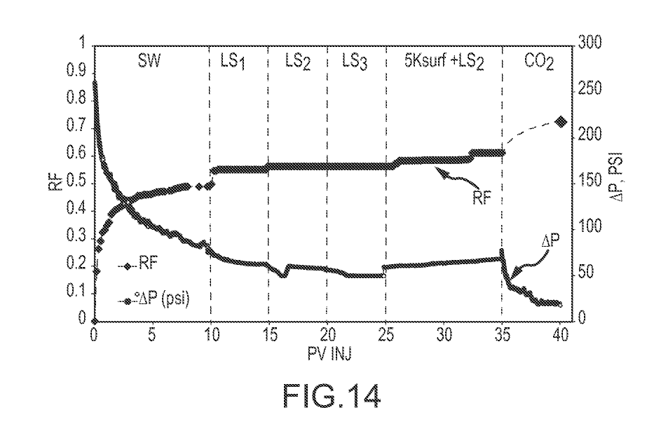

FIG. 14 and Table 8 illustrates RF and pressure difference between injection and production end (ΔP, psia) as a function pore volume injected. In this experiment, the connate water saturation was about 24.11%; RF during 10 PV SW flood was 48.93%. The RF during 5 PV each LS₁, LS₂, and LS₃ were 6.19%, 1.13%, and 0%, respectively. In all floods, 0.1 cc/min injection rate was applied.

Ten PV of 5,000 ppm surfactant diluted in LS₂ was injected following the SW and three sets of LS floods. 4.89% oil was recovered during this flooding sequence. Comparing the pressure drop (ΔP) at the beginning and end of 5,000 ppm surfactant+LS₂ flood shows that the ΔP increased by about 9 psia. This pressure build up was bigger than the previous core flood, and this could be due to the higher surfactant concentration and higher pore volume injected; hence, more surfactant adsorption can be expected. Note that, the surfactant concentration of this experiment is five times the previous one, and the PV injected is two times the previous experiment. Thus, the overall sequence of the flooding was about 10 PV SW injection, 5 PV each LS₁, LS₂, and LS₃ floods, about 10 PV injection of 5,000 ppm Surfactant+LS₂ (5Ksurf+LS₂) flood, and about 5 PV CO₂ flood.

Following the surfactant flood, five PV of CO₂ injection at miscibility pressure was performed at 0.3 cc/min. Additional 11.32% oil was recovered during this flooding sequence.

### Results

Core flood, IFT, and contact angle measurements relevant to the LSS-WACO₂ EOR process were performed and the following are the conclusions:
Coreflood experiment of LSS-WACO₂ EOR process show that residual oil mobilization is achievable in oil-wet carbonate formations.
Coreflood in low-permeability oil-wet carbonate cores show that the LSS-WACO₂ EOR process produces incremental oil up to twenty-five percent beyond water flooding.
Contact angle measurements indicate that wettability alteration and IFT reduction are the main oil-mobilizing mechanisms in the Relevant to LSS-WACO₂ EOR process.

Even though the coreflood experiments are continuous CO₂ flood after surfactant diluted in low-salinity flood, similar to conventional WAG approach, i.e. LSS-WACO₂ EOR process, would be suitable for most reservoirs to optimize oil recovery.

The favorable wettability alterations observed through contact angle measurements on carbonate, sandstone, and Three Forks core discs show that LSS-WACO₂ EOR process may be applied to sandstone and ultra-low permeability formations as well.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A method to enhance recovery of oil in a hydrocarbon reservoir, comprising:
injecting a low-salinity water into the reservoir;
injecting a surfactant diluted in an additional low-salinity water, wherein the salinity of the additional low-salinity water is less than or equal to a salinity of the low-salinity water; and
injecting a gas into the reservoir after the injection of the surfactant diluted in the additional low-salinity water.

2. The method of claim 1, wherein the low-salinity water injection, the surfactant diluted in the additional low-salinity water, and the gas injection are alternated until a water cut is greater than about 80%.

3. The method of claim 1, further comprising:
injecting a lower salinity water following the low-salinity water injection, wherein a salinity of the lower salinity water is lower than the salinity of the low-salinity water.

4. The method of claim 1, wherein the gas is at least one of a carbon dioxide, a natural gas liquid, a nitrogen, a liquid petroleum gas and combinations thereof.

5. The method of claim 1, wherein the gas is produced from the reservoir.

6. The method of claim 1, wherein the surfactant is at least one of a nonionic surfactant or an anionic surfactant.

7. The method of claim 6, wherein the surfactant is nonionic surfactant and is at least one of an ethoxylated alcohol, a polyoxyethylene glycol alkyl ether, an octaethylene glycol monododecyl ether, a pentaethylene glycol monododecyl ether, a polyoxypropylene glycol alkyl ether, a glucoside alkyl ether, a decyl glucoside, a lauryl glucoside, an octyl glucoside, a polyoxyethylene glycol octylphenol ether, a triton X-100, a polyoxyethylene glycol alkylphenol ether, a nonoxynol-9, a glycerol alkyl esters, a glyceryl laurate, a polyoxyethylene glycol sorbitan alkyl ester, a polysorbate, a sorbitan alkyl ester, a span, a cocamide MEA, a cocamide DEA, a dodecyldimethylamine oxide, a block copolymer of polyethylene glycol a polypropylene glycol, or a poloxamer.

8. The method of claim 1, wherein a concentration of the surfactant is between about 500 ppm to 10,000 ppm.

9. The method of claim 1, wherein the hydrocarbon reservoir is at least one of a carbonate reservoir, a shale reservoir and a sandstone reservoir.

10. The method of claim 1, wherein the low-salinity water is at least one of a desalinated seawater, a diluted seawater, a desalinated hydrocarbon reservoir formation water, a diluted hydrocarbon reservoir water, a river water, a lake water, or a produced hydrocarbon reservoir water.

11. The method of claim 1, wherein the reservoir is an oil-wet carbonate reservoir.

12. The method of claim 1, wherein the salinity of the low-salinity water is between about 0 ppm to about 40,000 ppm, and the salinity of the additional low-salinity water is less than the salinity of the low-salinity water and between about 0 ppm and about 40,000 ppm.

13. A method to enhance oil recovery from a hydrocarbon reservoir, comprising:
injecting high-salinity water into the reservoir;
injecting a low-salinity water into the reservoir following the injection of the high-salinity water, wherein a salinity level of the low-salinity water is less than a salinity level of the high-salinity water;
injecting a lower salinity water into the reservoir following the injection of the low-salinity water, wherein a salinity level of the lower salinity water is less than the salinity of the low-salinity water;
injecting a surfactant diluted in the lower salinity water into the reservoir; and
injecting a gas into the reservoir following the injection of the surfactant diluted in the lower salinity water; and
alternating the injection of the low-salinity water, the injection surfactant diluted in the lower salinity water and the gas injection into the reservoir.

14. The method of claim 13, wherein the gas is at least one of a carbon dioxide, a natural gas liquid, a nitrogen, a liquefied petroleum gas and combinations thereof.

15. The method of claim 13, wherein the high-salinity water is at least one of a seawater, a reservoir formation water and combinations thereof.

16. The method of claim 13, wherein the low-salinity water is at least one of a desalinated seawater, a diluted seawater, a desalinated hydrocarbon reservoir formation water, a diluted hydrocarbon reservoir water, a river water, a lake water, or a produced hydrocarbon reservoir water.

17. The method of claim 13, wherein the lower salinity water is at least one of a desalinated seawater, a diluted seawater, a desalinated hydrocarbon reservoir formation water, a diluted hydrocarbon reservoir water, a river water, a lake water, or a produced hydrocarbon reservoir water, and wherein the surfactant is a nonionic surfactant.

18. The method of claim 13, wherein the reservoir is an oil-wet carbonate reservoir, a shale reservoir or a sandstone reservoir.

19. The method of claim 13, wherein the alternating injection of the low-salinity water and the surfactant in the lower salinity water is repeated until a water cut is greater than about 80%.

20. A method to enhance recovery of a hydrocarbon in a reservoir, comprising:
waterflooding the reservoir with a high-salinity water;
injecting a first injection of a low-salinity water into the reservoir, wherein at least about 0.1 of a pore volume of the reservoir is occupied by the low-salinity water;
injecting a surfactant diluted in an additional low-salinity water into the reservoir, wherein at least about 0.1 of the pore volume of the reservoir is occupied by the surfactant diluted in the additional low-salinity water;
injecting a gas into the reservoir wherein at least about 0.1 of the pore volume of the reservoir is occupied by the gas; and
alternating, in any order, at least one additional injection of the low-salinity water into the reservoir, at least one additional injection of the surfactant diluted in the additional low-salinity water into the reservoir, and at least one additional injection of the gas into the reservoir.
